(19) United States
(12) Patent Application Publication
(10) Pub. No.: US 2003/0074370 A1
(43) Pub. Date: Apr. 17, 2003

(54) System and method for object based delivery of on-line courses and content

(76) Inventors: Sharon R. Gargano, Princeton Junction, NJ (US); Elizabeth N. Moriarty, Morristown, NJ (US); Joseph Infozino, Yardley, PA (US)

Correspondence Address: MORGAN & FINNEGAN, L.L.P., 345 Park Avenue, New York, NY, 10154-0053, US

(21) Appl. No.: 09/975,816

(22) Filed: Oct. 12, 2001

(51) Int. Cl. G06F 7/00

(52) U.S. Cl. 707/103 R

(57) ABSTRACT

A system and method for object based delivery of on-line courses and content. The system and method can be used, for example, to develop instructional and educational content. Information stored on the system may be searched and reused in developing a new course. Alternatively, new content may be created using the system. The system and method includes administrative functions to monitor the development of content and the efficient use of the system.

### FIELD OF THE INVENTION

This invention relates to a system and method for object based delivery of on-line courses and content. The system and method can be used to facilitate creation and use of instructional and educational content from any one of, or a combination of, various files.

### BACKGROUND

There are a number of ways currently in use for delivering courses and content. For example, content can be distributed as desktop software with updates distributed as new versions of the software. Content is also accessible on the internet, which can be updated as part of a website update. Content delivered in these ways is not easily reused.

With respect to current instructional and education content, a significant disadvantage is that due to the way in which the course is delivered, material cannot be reused when one part of the program becomes outdated. While there are separate and distinct courses available, those courses cannot be broken down into re-useable information units. This is problematic in that an update to a portion of the course may require that the entire course be revamped. Similarly, content originally presented as parts of separate courses cannot be easily integrated and may require creation of wholly new course.

In addition, in some cases the author of content does not have the ability to create the content for on-line use. The author may have to describe the desired content to a programmer who then creates the on-line content. This takes development control away from the source where the information originates and can delay the creation of the content. For example, an author may have to contact a programmer to have minor edits or style-type inaccuracies corrected. This slows down the turnaround time for the delivery of new content and can lead to errors.

### SUMMARY

The system and method addresses the above-mentioned problems to facilitate delivery of on-line courses and content. The system and method can be used, for example, in the creation and use of instructional and educational content.

Using the system and method, a user can search through content existing on the system and reuse that content in the creation of new courses and content. In addition, using the system and method, new information may be entered as part of a new course or content. Thus, new courses and content may be created by a new combination of already existing content, newly entered information or the combination of existing content and newly entered information.

When creating new courses and content, a user may reuse or create new content from the smallest unit of information available to the system or may reuse or create new content from higher up in the organizational hierarchy of information within the system. The user has a variety of choices as to style, presentation or type of content (e.g. audio, text or video). Because information can be reused or created at any level in the organizational hierarchy, the system is easy to learn and use and promotes efficiency.

The system and method includes administrative functions to monitor the development of content and the efficient use of the system.

### BRIEF DESCRIPTION OF THE DRAWINGS

FIG. 1 is a diagram of an embodiment of representative hardware for use in the system and method.

FIG. 2 is a diagram of an embodiment of a representative functional architecture for use in the system and method.

FIGS. 3-5 are flow diagrams showing embodiments of representative processes for use in the system and method.

FIGS. 6-16 are embodiments of representative screen displays for use in the system and method.

### DETAILED DESCRIPTION OF THE PREFERRED EMBODIMENT

1. Hardware

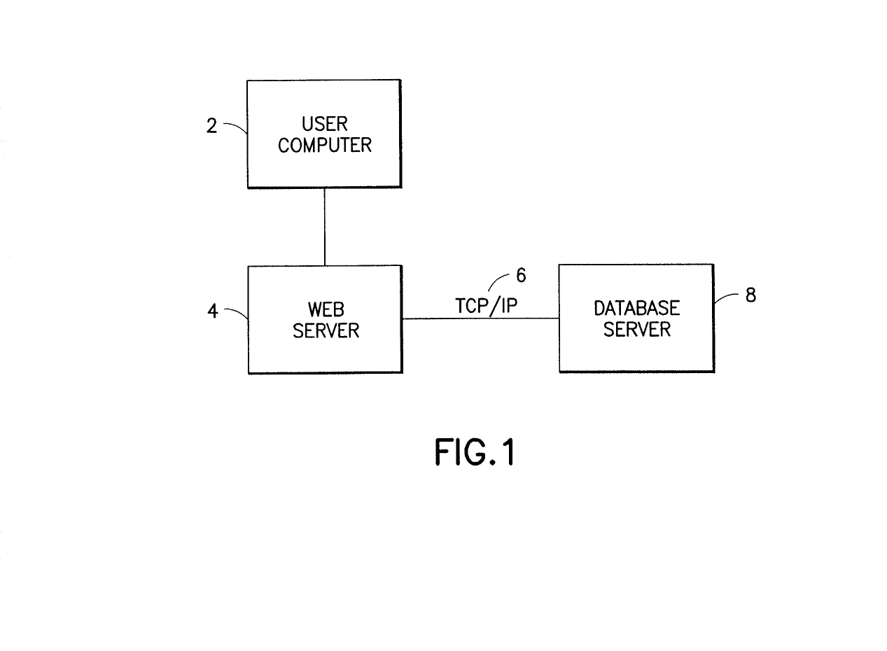

FIG. 1 is a representative hardware configuration of the system and method. A user's computer 2 accesses a Web Server 4, which then accesses the database server 8 via a Transmission Control Protocol/Internet Protocol (TCP/IP) connection 6. The database server determines the user's request and provides the appropriate functionality, and/or storage and response necessary to the user through the Web Server.

Peripheral devices (other than the user's computer 2) may be attached to the servers 4 and 8 for any number of purposes including, but not limited to: printers for output, scanners for input, additional or alternative storage devices for data storage and retrieval, network interfaces for communication, and devices of the like.

Each of the servers 4 and 8 may be based on common programmed computer systems that may include, but are not limited to, components such as: a central processing unit (CPU); and various forms of memory such as, but not limited to: read only memory, random access memory (RAM), and a local storage device. The CPU is electronically coupled to each of the central controller's other elements. The CPU comprises at least one high-speed data processor adequate to execute program modules for executing user or system-generated requests. Preferably, the CPU is a conventional microprocessor. The CPU interacts with RAM, ROM, and storage device(s) to execute stored program code according to conventional data processing techniques.

Each of the servers 4 and 8 have a conventional operating system comprised of executable program code enabling the operation of a centralized controller. The operating system facilitates access of storage devices, I/O, network interfaces devices, peripheral devices, etc. The operating system, once executed by the CPU, interacts with ROM, RAM, I/O, peripheral devices, user input devices, storage devices, communications networks, program modules, and data, etc. Preferably, the operating system includes communication protocols that allow the centralized controller to communicate with other entities through a communications network. As shown in FIG. 1, the preferred protocol is TCP/IP.

As would be appreciated by a person skilled in computer architecture, the functions performed by each of the servers 4 and 8 shown in FIG. 1 could be as consolidated into a single server or could be distributed across multiple serves or components. Thus, the functionality of the servers may be combined or distributed in any number of ways to facilitate deployment.

2. Architecture

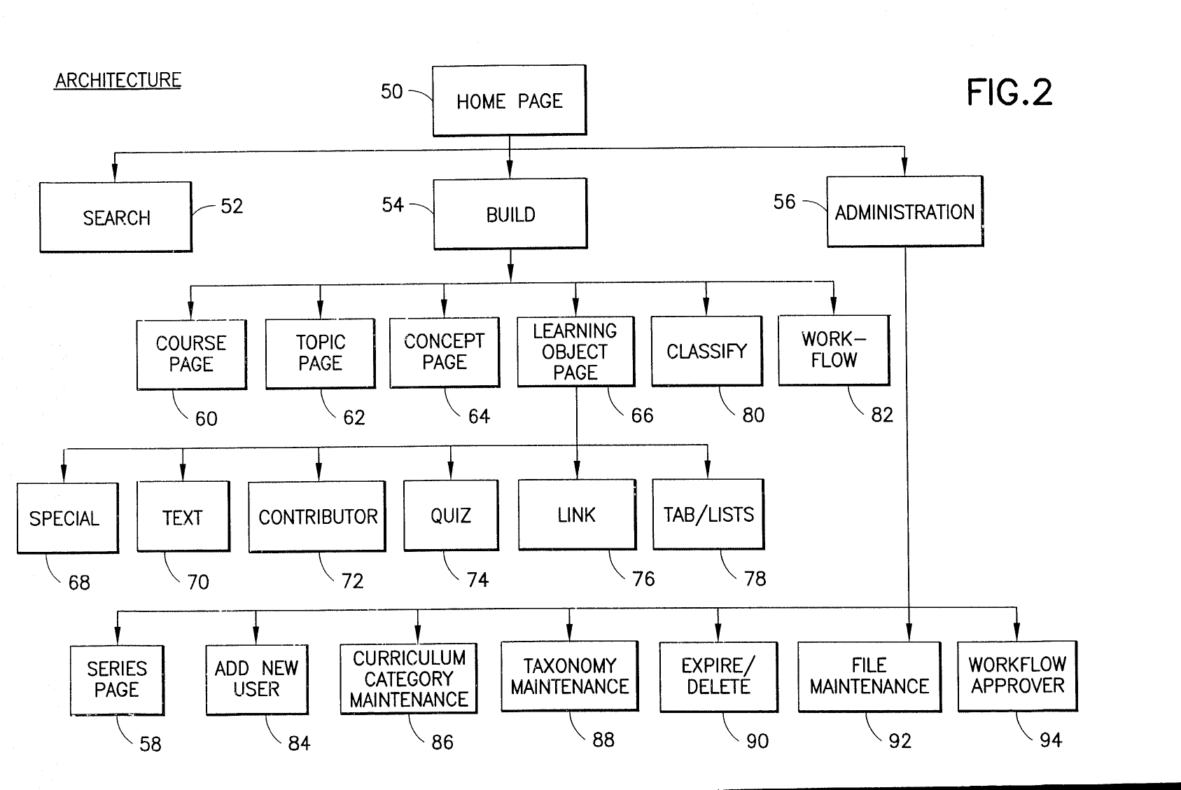

FIG. 2 is a diagram of an embodiment of a representative functional architecture for use in the system and method. Using the system and method, the user has access to a home page 50. From the home page 50, a user can invoke Search 52 and Build 54 functions and may be able to invoke an Administration function 56. The Search function 52 is used to search current courses and content stored in the system.

The Build function 54 is used to create courses and content. As part of the Build function 54, the user may access a Course Page 60, Topic Page 62, Concept Page 64 or Learning Object 66. A Course Page 60 is used to record certain information when creating a course. A course can be broken down into topics. A Topic Page 62 is used to record certain information when creating a topic. A topic can be broken down into concepts. A Concept Page 64 is used to record certain information when creating a concept. A concept can be broken down to objects (the smallest unit of information stored in the system). A Learning Object Page 66 is used to record certain information when creating an object. There are a number of types of Learning Objects used in the system and method. For example, Learning Objects may include Special 68, Text 70, Contributor 72, Quiz 74, Link 76, and Tab/Lists 78 Learning Objects.

A Special Learning Object 68 is used to create a unique Learning Object for a Specialized purpose. A Text Learning Object 70 is used to collect text, images, attachments and quotes to convey a single idea. A Contributor Learning Object 72 is used to provide information regarding the author of contributing material. A Quiz Learning Object 74 is used to create a test. A Link Learning Object 76 is used to add a Link to other material. A Tab/Lists Learning Object 78 is used to display information to the learner in a dynamic fashion.

Once the user has completed the creation of a course or parts of a course, he can Classify 80 Learning Objects using the defined categories to enable users to more easily search for those Learning Objects on the system. The user can also record his progress by updating a Workflow 82 Module, which is used to maintain a record of work done by the user on the various projects that are his responsibility.

Some users of the system and method will have the authority access to the Administration 56 function to perform administrative tasks. Some of those administrative tasks include Series Page 58, Add New User 84, Curriculum Category Maintenance 86, Taxonomy Maintenance 88, Expire/Delete 90, and File Maintenance 92.

The Series page 58 is used to group related courses that define a curriculum or level of competency in a particular subject matter area. A administrator can create a Series by entering on the Series Page the courses defining the curriculum, for example, the titles of the courses, and titles, introduction or descriptive Text for the series. The administrator can determine which courses to include in the Series using the search function.

Using Add New User 84, a new user may be added to the system. Using Curriculum Category Maintenance 86 certain courses can be grouped together to define a curriculum group and curriculum groups may be added, deleted or modified. Using Taxonomy Maintenance 88 course details pertaining to core categories and the subject areas that are assigned to a certain competency level can be added, removed, renamed, and/or modified. Using Expire/Delete 90 content on the system can be searched, previewed, expired (i.e. removed from a given course, but not deleted) and/or deleted. Using File Maintenance 92 files that are needed by authors to create courses can be uploaded, unnecessary files can be deleted and files can be renamed to adhere to naming standards.

Administrators also have access to Workflow Approver 94. Using Workflow Approver 94, the status of all areas of a course (e.g. Topic Pages 62, Concept Pages 64 and Learning Objects 66) can be reviewed for adherence to course standards, quality etc. Upon review, a course can be advanced to publishing (i.e. placing the course on the system for use by others) or placed on hold until additional work is completed.

3. Search Function

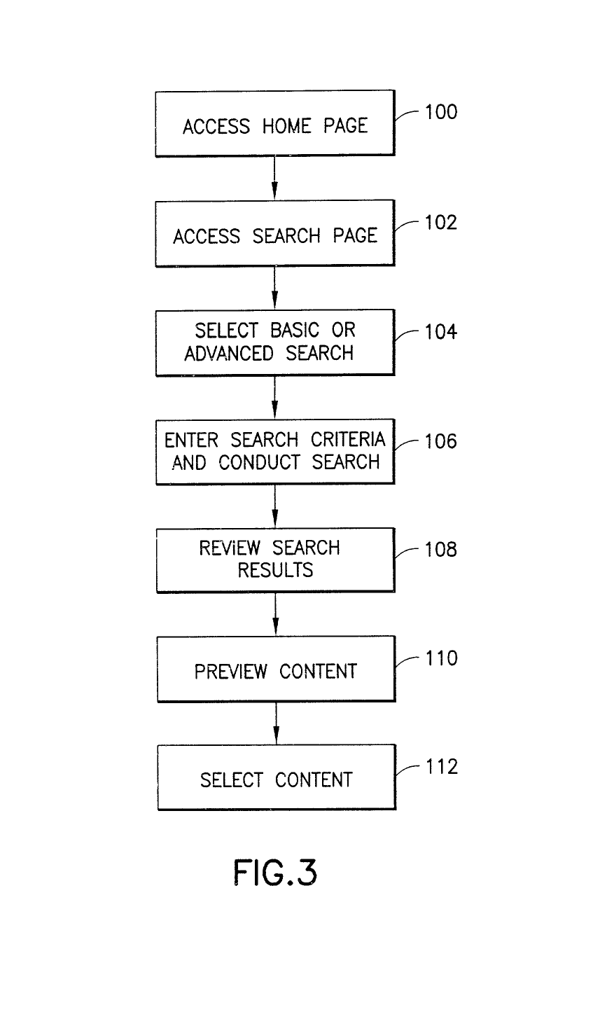

FIG. 3 is a flow diagram showing an embodiment of a representative search process for use in the system and method. The system may contain preexisting educational and instructional content. Using a search function, a user can search the system for the preexisting content.

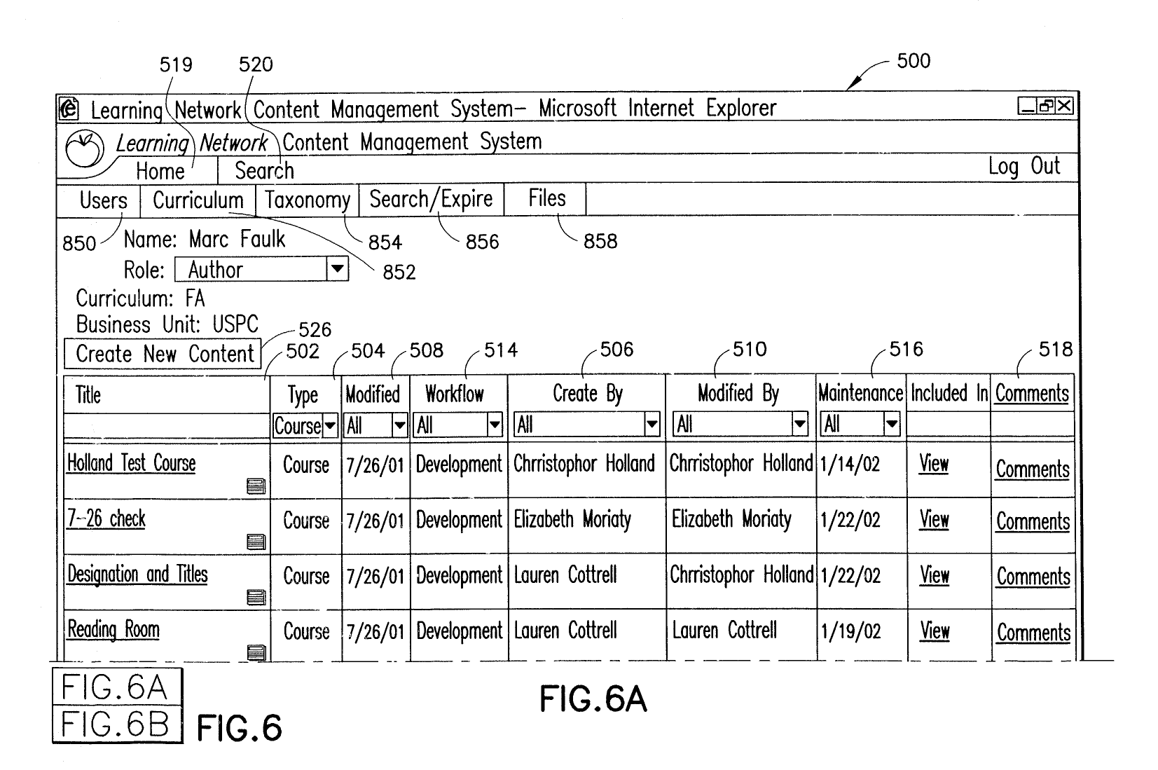

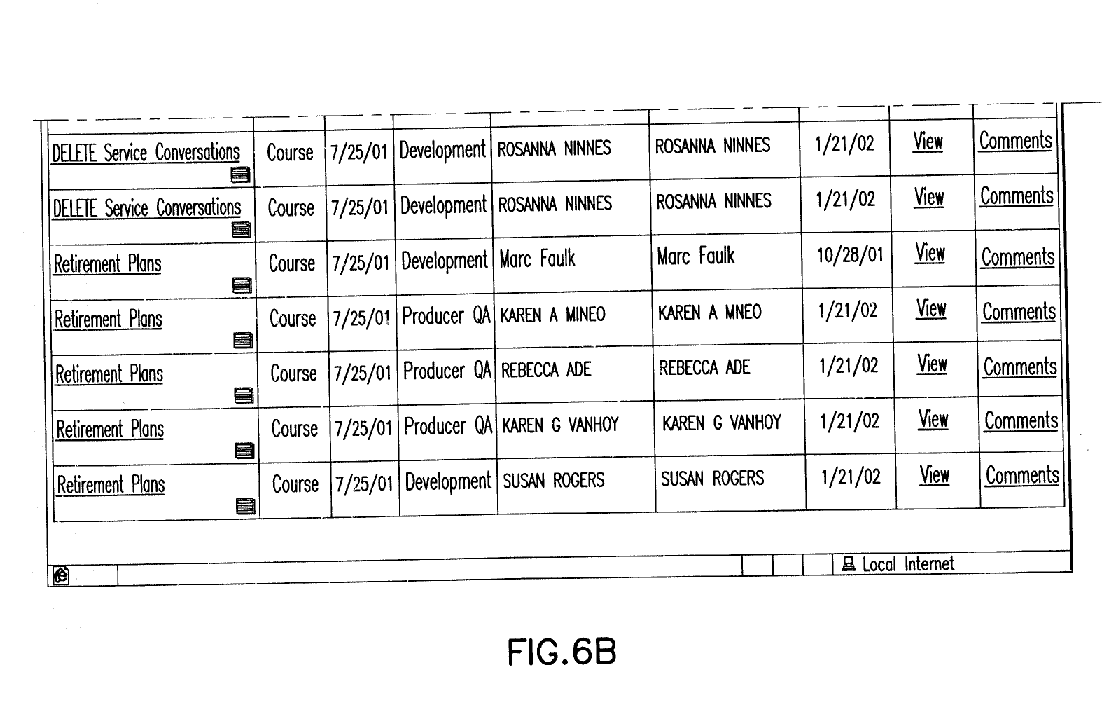

After accessing a home page (step 100 in FIG. 3), the user can conduct a search. FIG. 6 is an embodiment of a representative home page screen display 500 for use in the system and method. The home page list the titles 502 of courses that the user has access to or has created. For each of the courses, there are number of fields including, for example, type 504, author 506, date modified 508, modified by 510, workflow status 514 and maintenance required 516. These fields can be used to sort the courses. There is an additional field for comments 518 for each of the courses. The home page also includes Home 519, Search 520, Users 850, Curriculum 852, Taxonomy 854, Search/Expire 856, Files 858 and Create New Content 526 buttons.

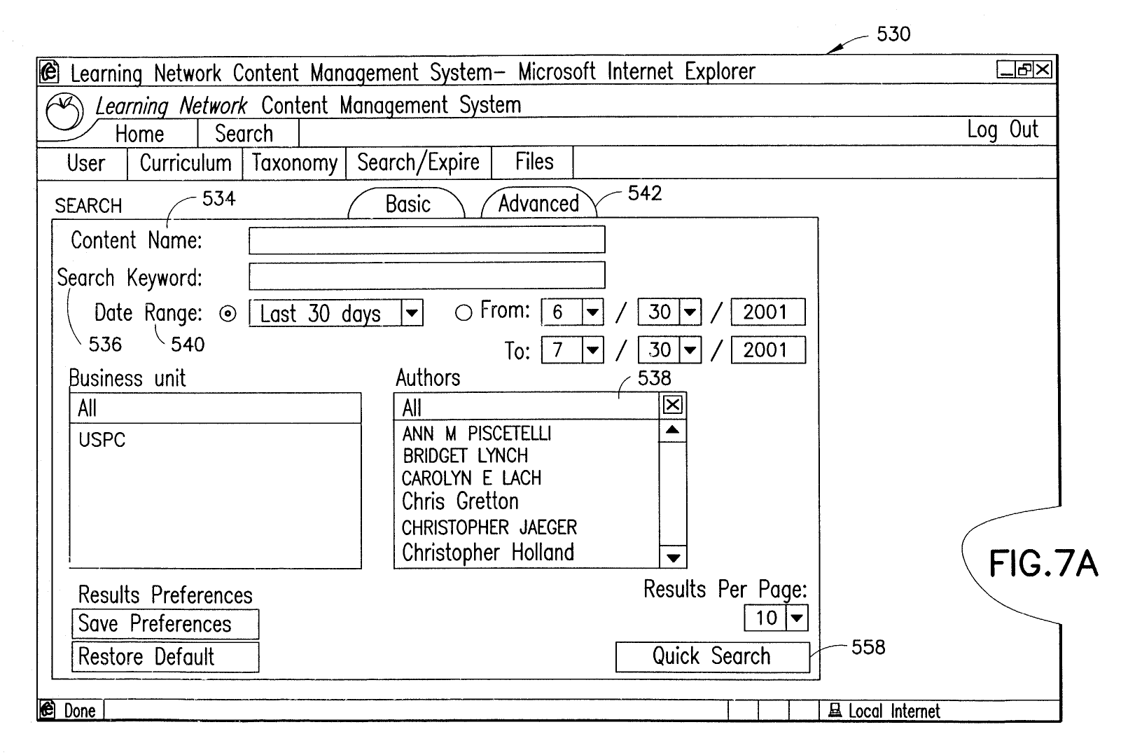

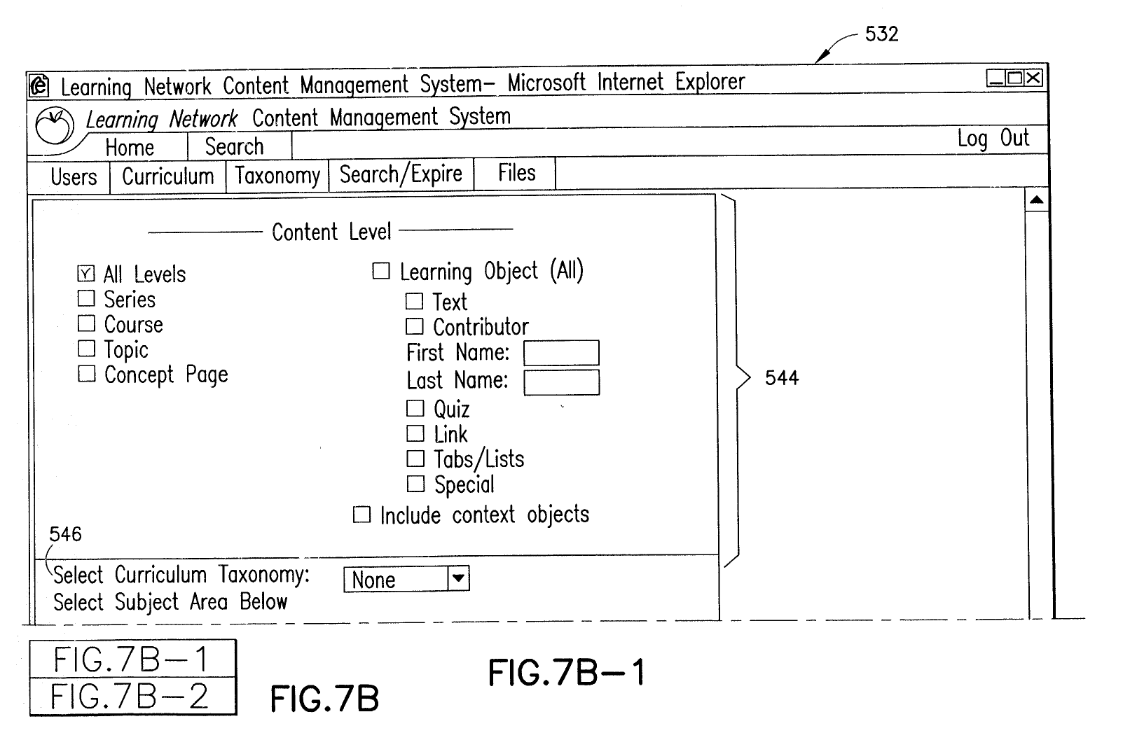

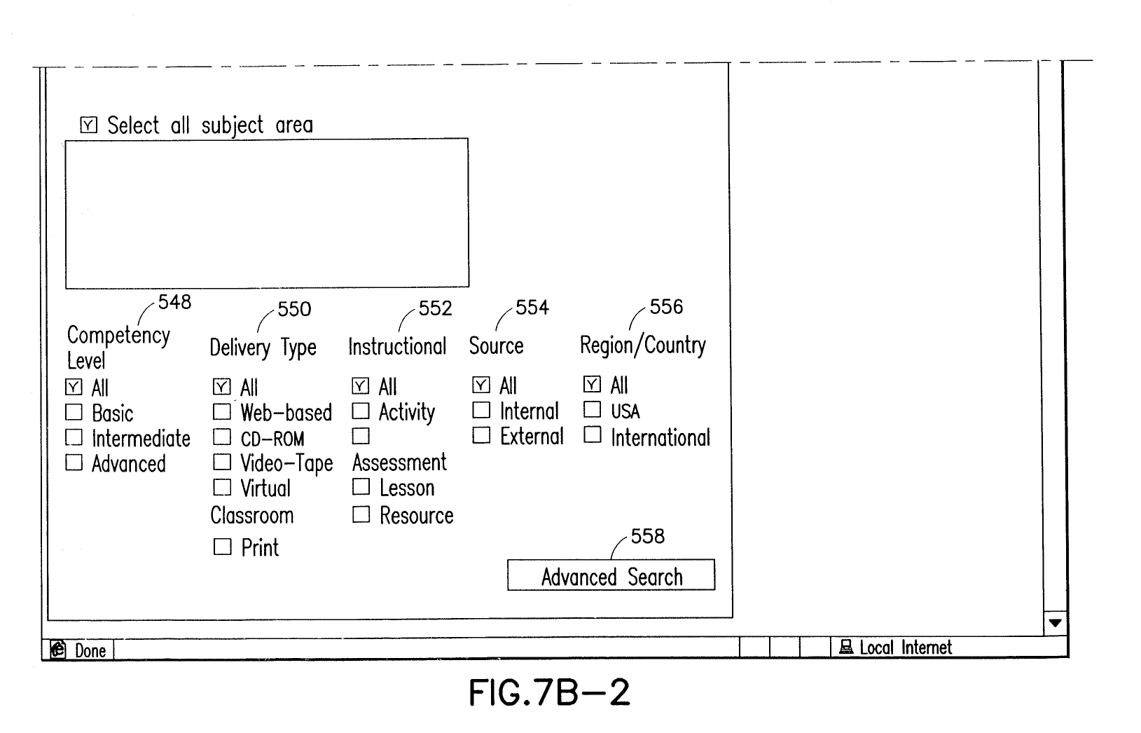

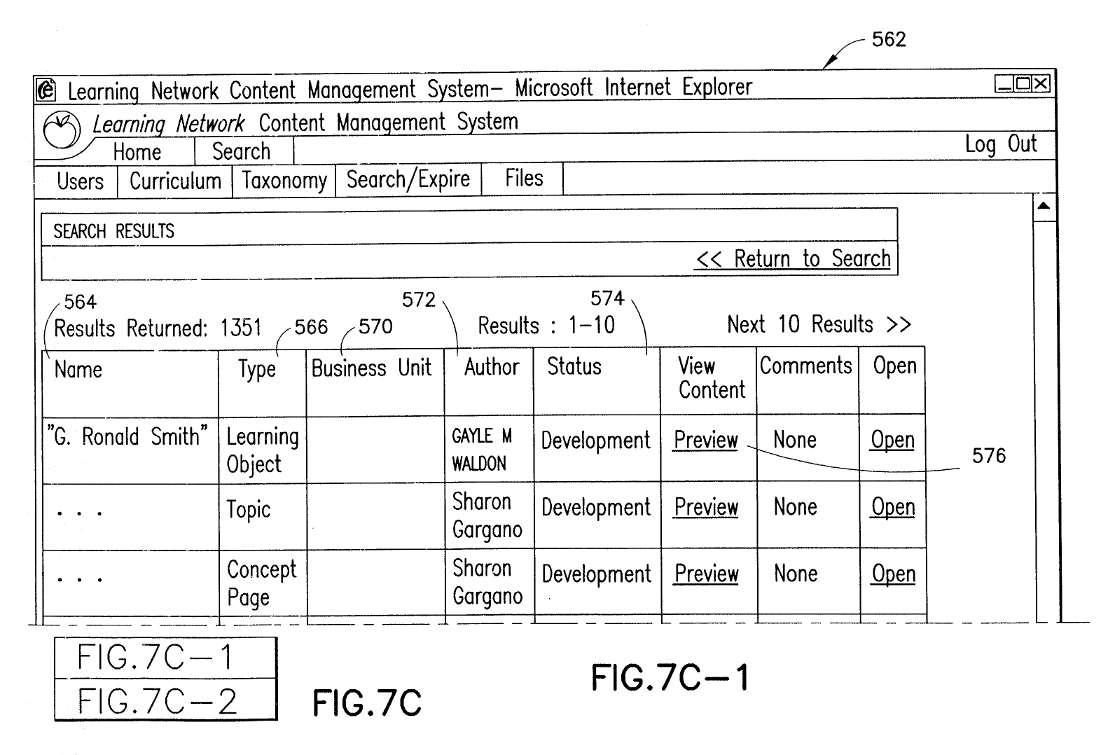

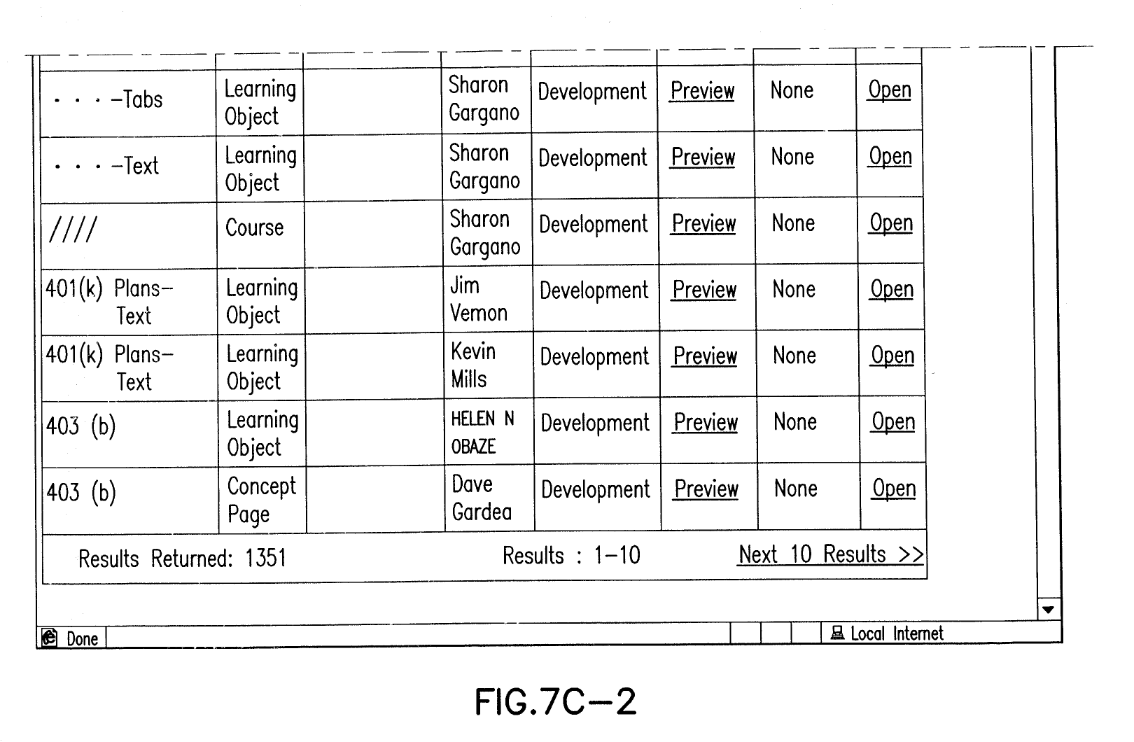

To conduct a search, the user clicks on the Search button 520. The Search button 520 provides access to a Search Page (step 102 in FIG. 3). FIGS. 7A and 7B are embodiments of a representative search page screen displays 530 and 532 for use in the system and method. As shown in FIG. 7A, using a basic search, a user may search for a course component based on certain search criteria, including, for example, content name 534, keywords 536, author 538 and date range 540. The user may conduct an advanced search by clicking on the Advanced Search button 542. As shown in FIG. 7B, using an advanced search, additional criteria may be entered including, for example, content level 544 (e.g. Series, Course, Topic, Concept Page or Learning Object type), curriculum taxonomy 546 competency level 548, delivery type 550, instructional type 552, source 554, and region/country 556.

After accessing a Search Page 530 and 532, the user selects a basic or an advanced search (step 104 in FIG. 3). After selecting the type of search, the search criteria are entered (step 106 in FIG. 3) and, by clicking on the Search button 558 on either FIGS. 7A or 7B, the search is begun.

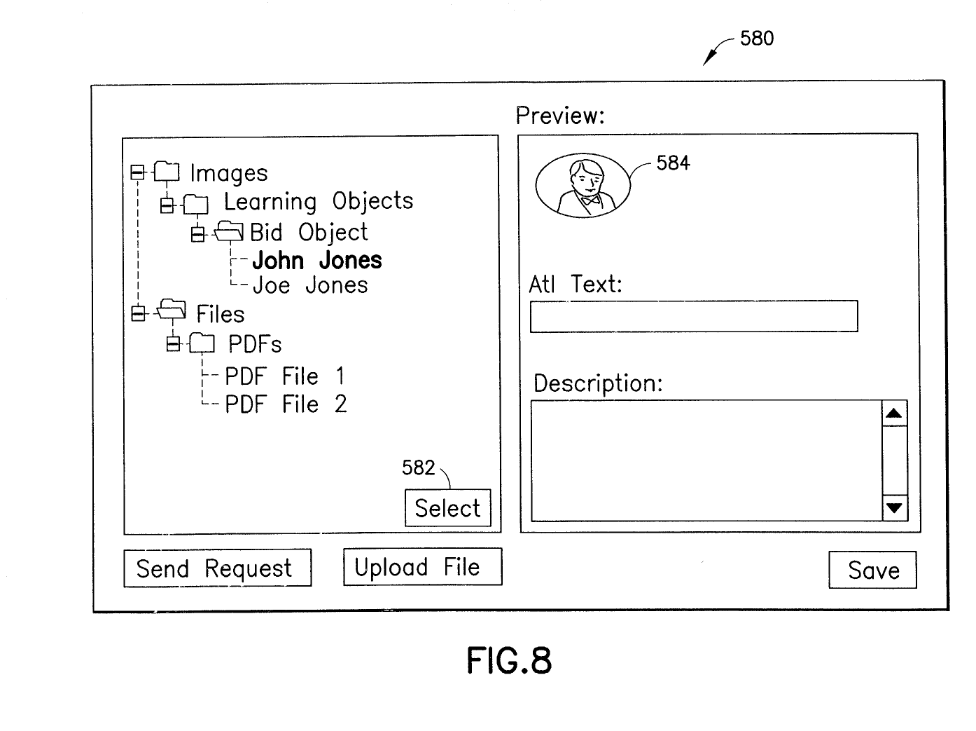

After the search is completed, the search results are displayed for review (step 108 in FIG. 3). FIG. 7C is an embodiment of a representative search results screen display 562 for use in the system and method. The search results can include, for example, user name 564, type of learning component 566 (e.g. Topic Page, Concept Page or Learning Object Page), the business unit responsible for the course 570, author 572 and status 574. The search result can also be previewed (step 110 in FIG. 3) and selected or retrieved (step 112 in FIG. 3). For example, by clicking on the Preview button 576, the user can preview any particular course component. FIG. 8 is an embodiment of a representative preview screen display 580 for use in the system and method. When a user clicks on a preview button 576 for a desired file, a preview of that file will appear on the preview screen display 580. In FIG. 8, the image at 584 shown is being previewed. From either the search results or preview screen displays, the user can open or select a particular learning component by clicking on the Preview 576 or Select 582 buttons.

4. Build Function

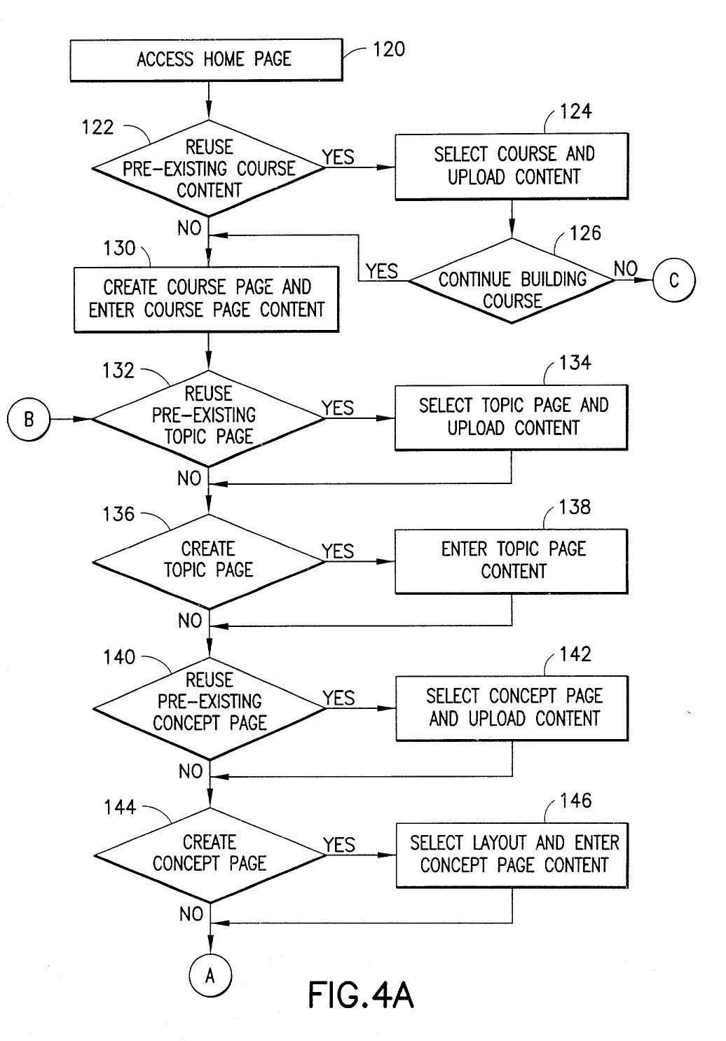

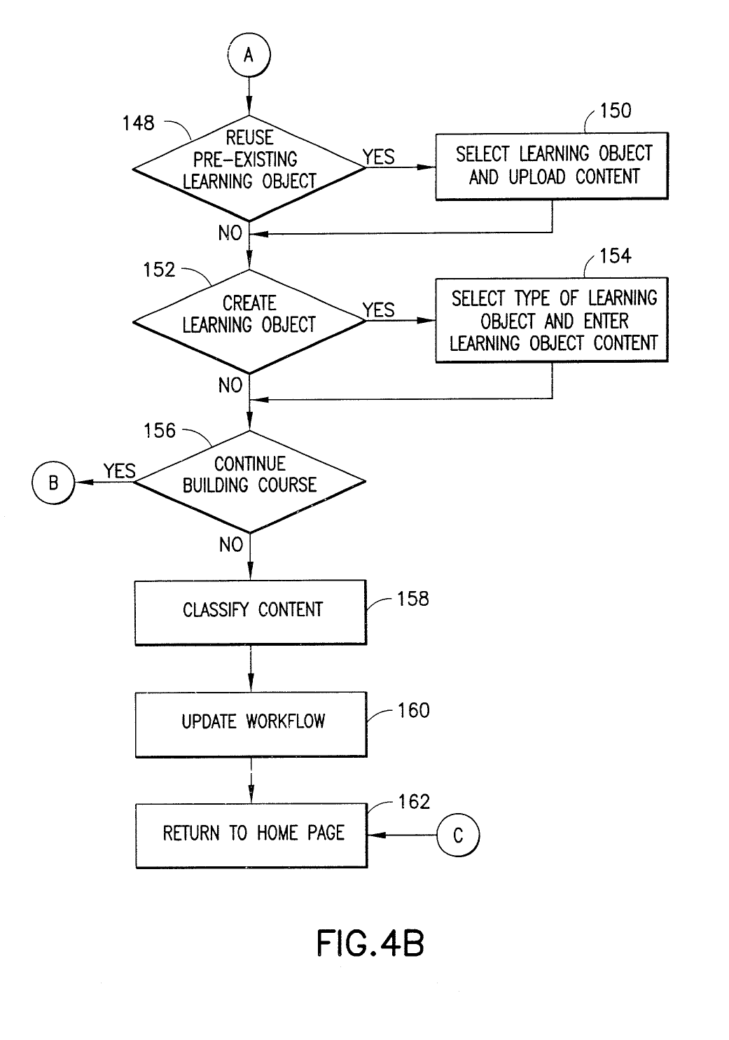

From the home page of FIG. 6, the user can invoke the Build Function by clicking on the Create New Content button 526. FIGS. 4A and 4B are embodiments of representative flow diagrams of the process of building course content using the system and method. As shown in FIG. 4A, after accessing the home page (step 120) and based on the results of a search, the user can decide to reuse preexisting course content (step 122). If the user decides to reuse preexisting course content, he can select and upload that course content (step 124). The user can continue building course content (step 126) or he may exit the process (step 162). If the user decides to continue building course content (step 126) or he does not want to use preexisting course content (step 122), he can create course content.

As an initial step in creating course content the user can create a scope document and/or an outline of the content that the user would like to create. The system and method can provide a scope document page and work pad which are used to capture background information for building a course. For example, the scope page can be used to record information including a course overview, course objectives and the intended audience. On the scope page, the author can organize his thoughts and ideas for the course. The work pad can be used more like a “scratch pad” for the author. The author can use this area to generate ideas for a course outline or to store a course file information and to jot down various notes and reminders.

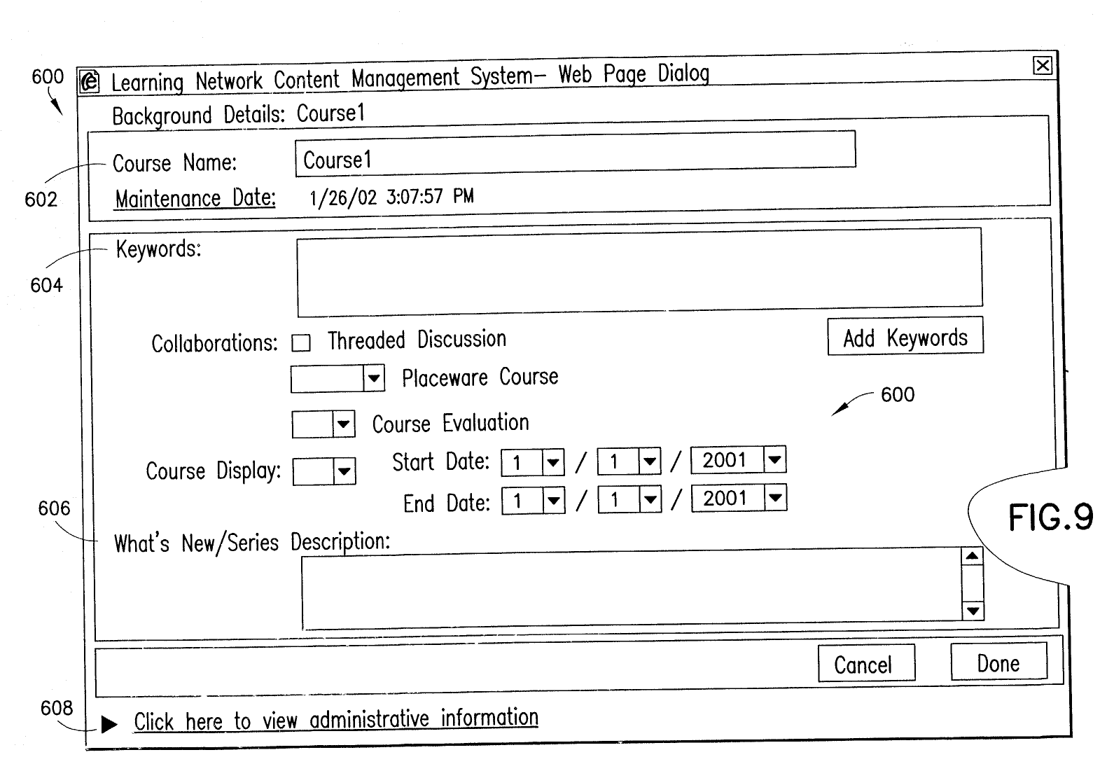

The user then creates a Course Page (step 130 in FIG. 4A). The Course Page is used to record certain information when creating a new course. FIG. 9 is a embodiment of a representative Course Page screen display 600. As shown in FIG. 9, the Course Page can include, for example, course name 602, keywords that can be used for searching 604 and a brief course description 606. In addition, administrative information may be viewed and entered by clicking on 608. This may include the owner, business unit, author, date of creation, the last person that modified the document and the date of the last modification and is stored as part of the Course Page.

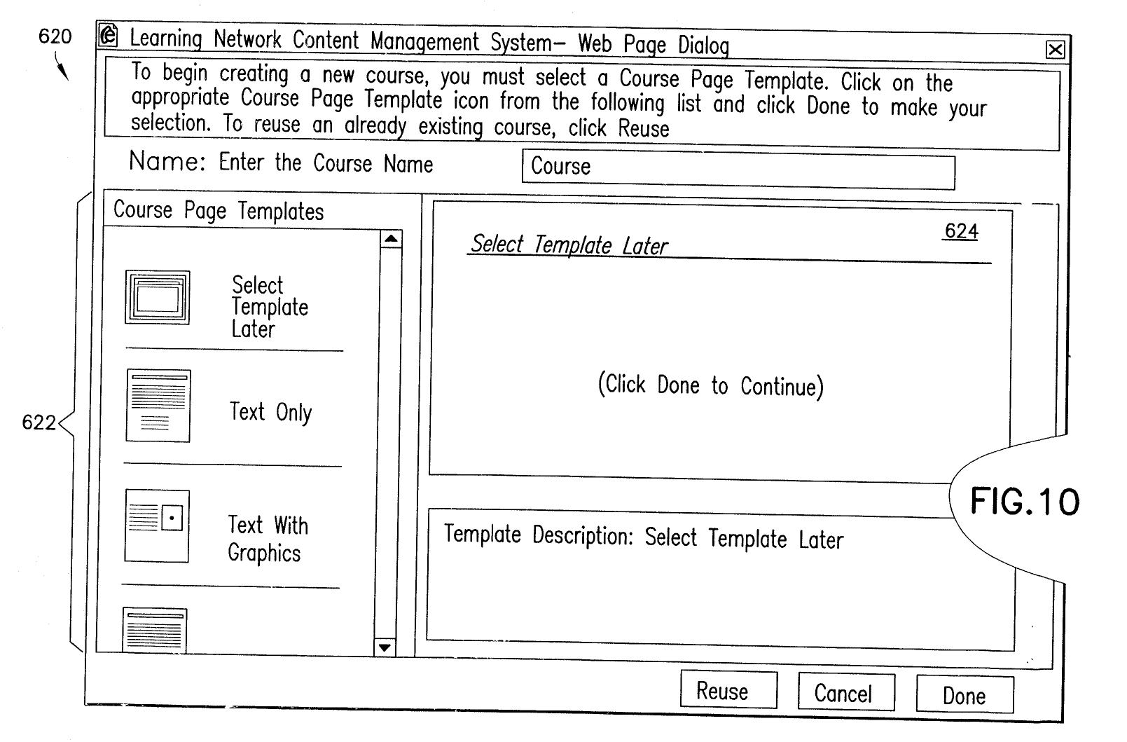

Creating a Course Page also may include selecting a template to be use as part of a course. FIG. 10 is an embodiment of a representative Course Page template selection screen display 620. As shown in FIG. 10, the Course Page template selection screen display provides a list of available templates 622 that can be use to create a course including, for example, the names of the templates and accompanying image. By clicking on the image, a larger picture of the template can be shown on the screen display. The right side of the screen display 624 can show the Course Page as it would appear to a person taking the course, in the template selected by the user. In FIG. 10, “Select Template Later” has been chosen by the user so that nothing is displayed at 624.

Returning to FIG. 4A, as part of the course development, the user can use a preexisting Topic Page (step 132). If the user wants to use a preexisting Topic Page, he can select that topic and upload the Topic Page content into the course he is creating (step 134). If the user selects and uploads a Topic Page or if the user decides not to use a preexisting Topic Page, he can create a new Topic Page (step 136). Creating a new Topic Page requires entering the contents of the Topic Page (step 138). The Topic Page is used to record certain information required when creating a new topic.

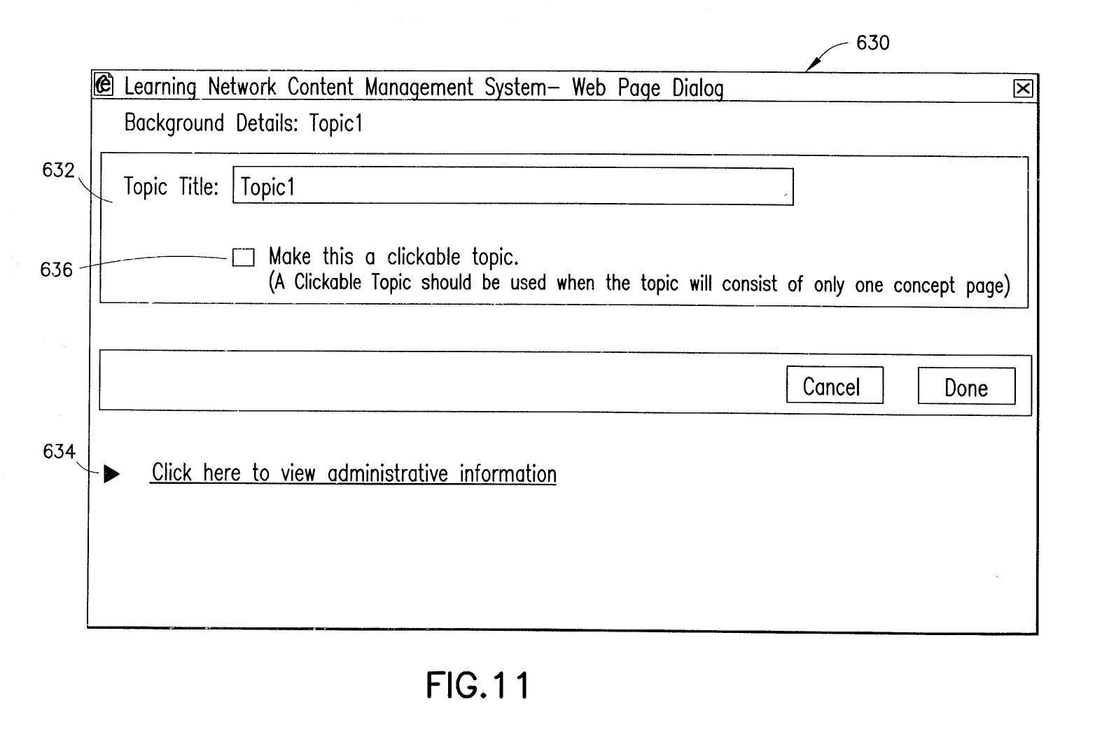

FIG. 11 is an embodiment of a representative Topic Page screen display 630. As shown in FIG. 11, the Topic Page can include, for example, a title 632 and style (clickable or non-clickable) 636. Administrative information regarding a specific topic may be viewed and entered by clicking on 634. This may include the owner, business unit, author, date of creation and date of last modification and is stored as part of the Topic Page.

In continuing to develop a course, as shown in FIG. 4A, the user can reuse a preexisting Concept Page (step 140). If the user decides to do so, he can select the preexisting Concept Page and upload the content of that page into the course he created (step 142). If the user selects and uploads a Concept Page or if the user decides not to reuse a preexisting Concept Page, he can create a new Concept Page (step 144). Creating a new Concept Page requires selecting a layout and entering the content of the Concept Page (step 146). A Concept Page is used to record certain information required when creating a new concept.

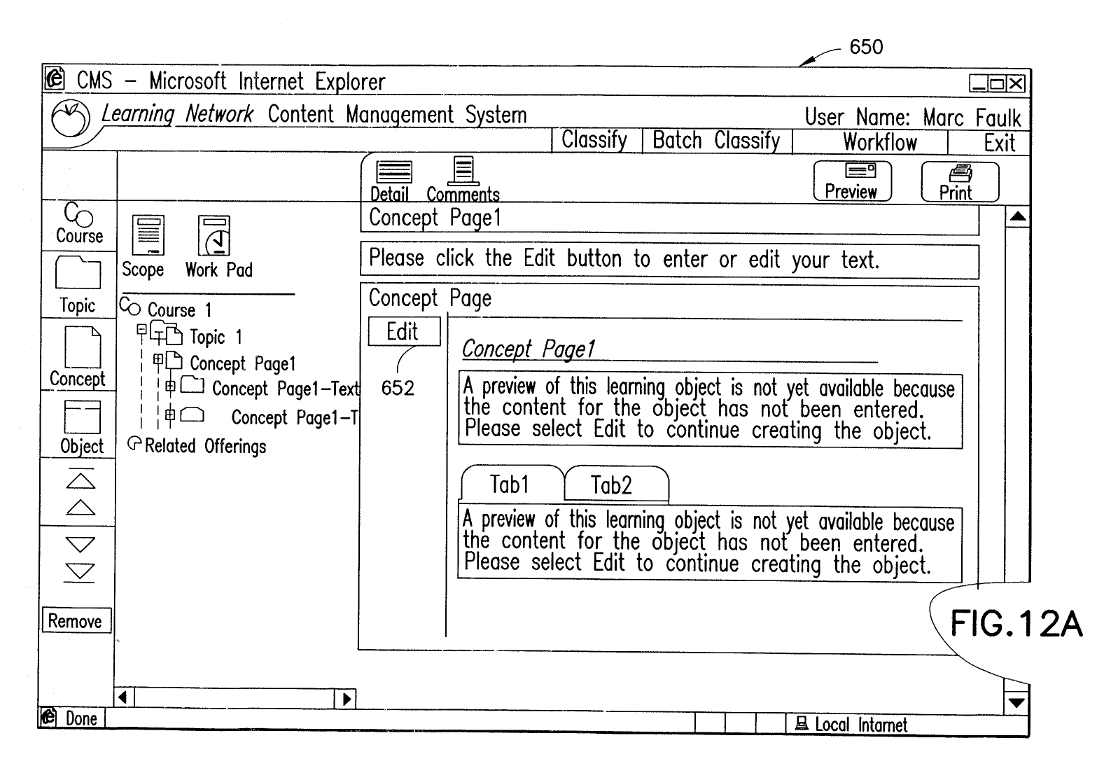

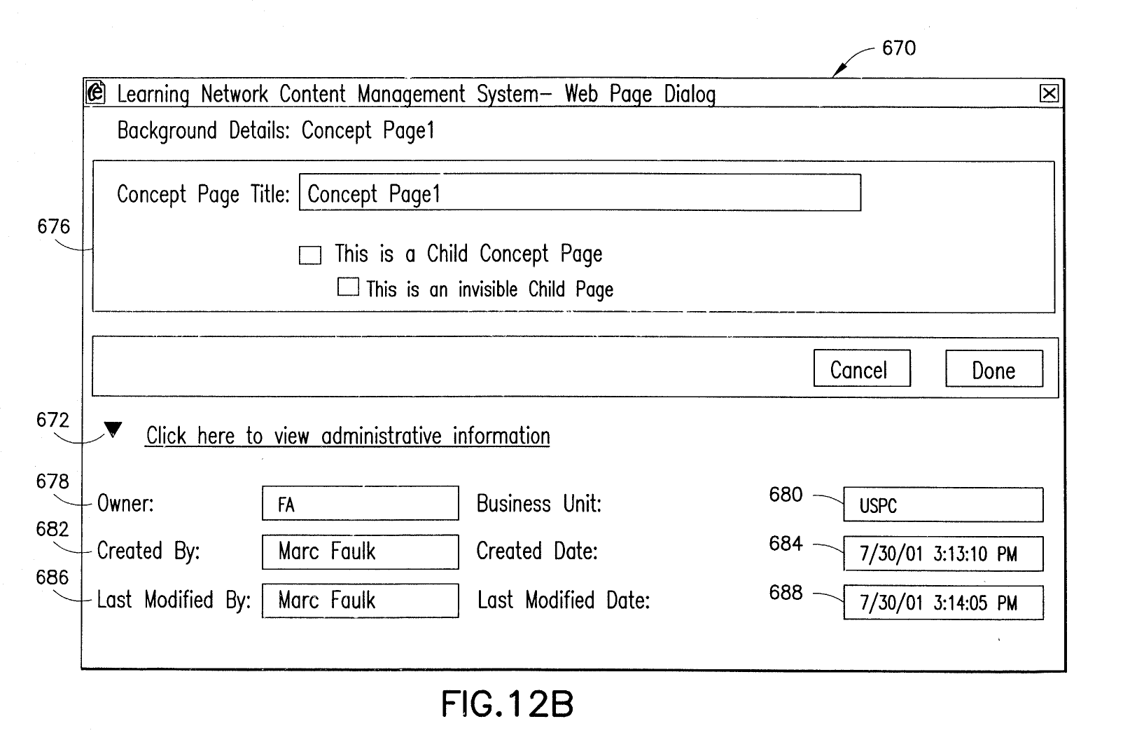

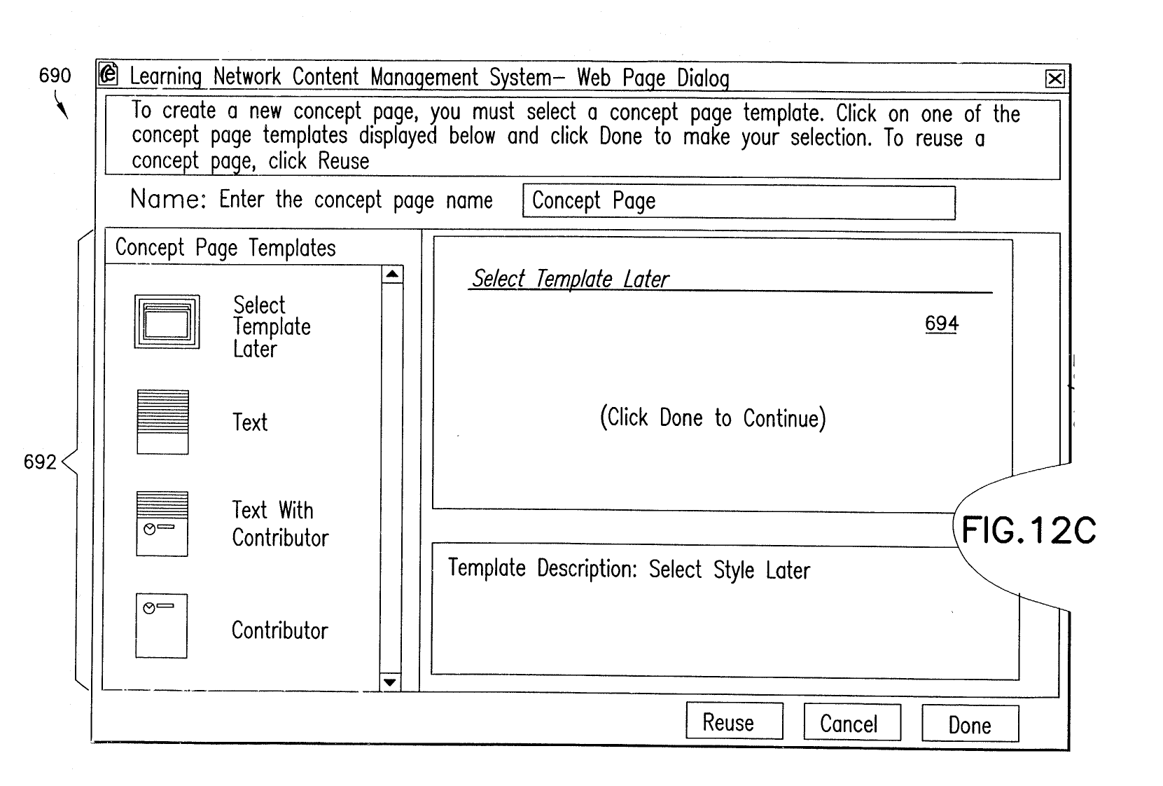

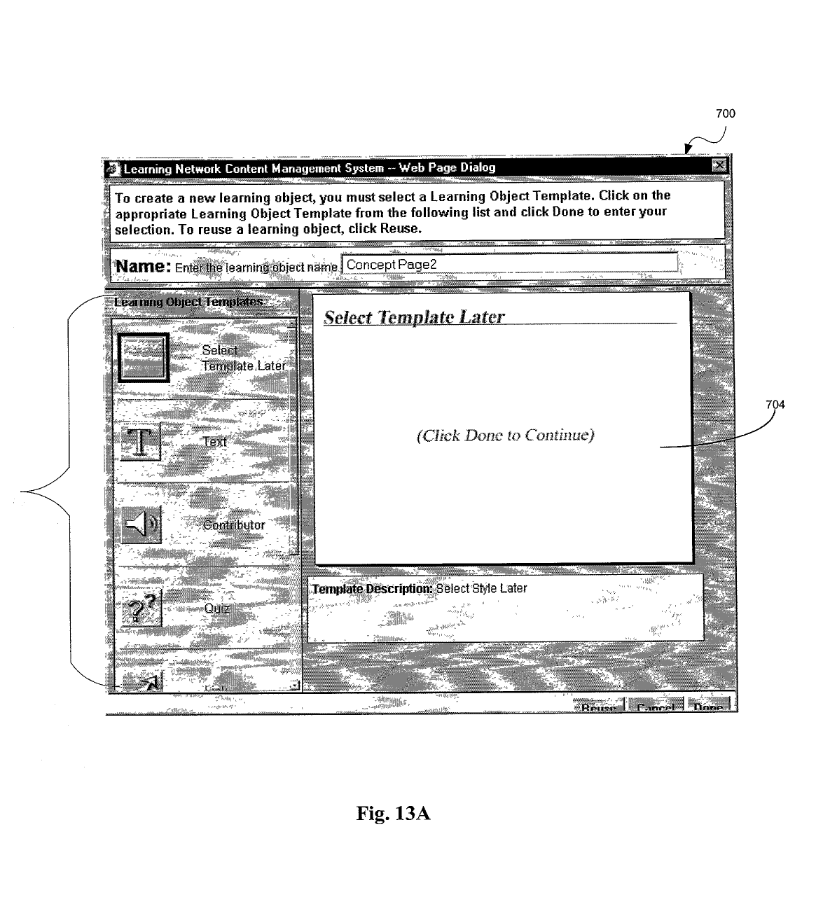

FIG. 12A is an embodiment of a representative Concept Page screen display 650 for entry of content. To place content on the Concept Page screen display 650, the author uses the Edit button 652. FIG. 12B is an embodiment of a representative Concept Page details screen display 670. The Concept Page details screen display 670 may include, for example, the Concept Page title 676. Administrative information may be viewed and entered as part of the Concept Page by clicking on 672. This may include the owner 678, business unit 680, author 682, date of creation 684, the last person who modified the Concept Page 686 and the date of the last modification 688 and is stored as part of the Concept Page. Finally, FIG. 12C is an embodiment of a representative Concept Page templates selection page 690. The Concept Page template sheet selection page 690 provides a list of available templates an author can use to create a Concept Page 692. By clicking on the image of various templates, a larger picture of the templates can be shown on the screen display. The right side of the screen display 694 can show the Concept Page as it would appear to a person taking the course, in the templates selected by the user. In FIG. 12C, the “Select Template Later” has been chosen by the user so that nothing is displayed at 694.

Continuing to develop the course, as shown in FIG. 4B, the user can reuse a preexisting Learning Object (step 148). If the user selects and uploads a Learning Object Page or if the user decides to reuse a preexisting Learning Object, the Learning Object is selected and the content of that object is uploaded into the course that is being created (step 150). If the use selects and uploads a Learning Object Page or if the user decides not to reuse a preexisting Learning Object, he may create a new Learning Object (step 152).

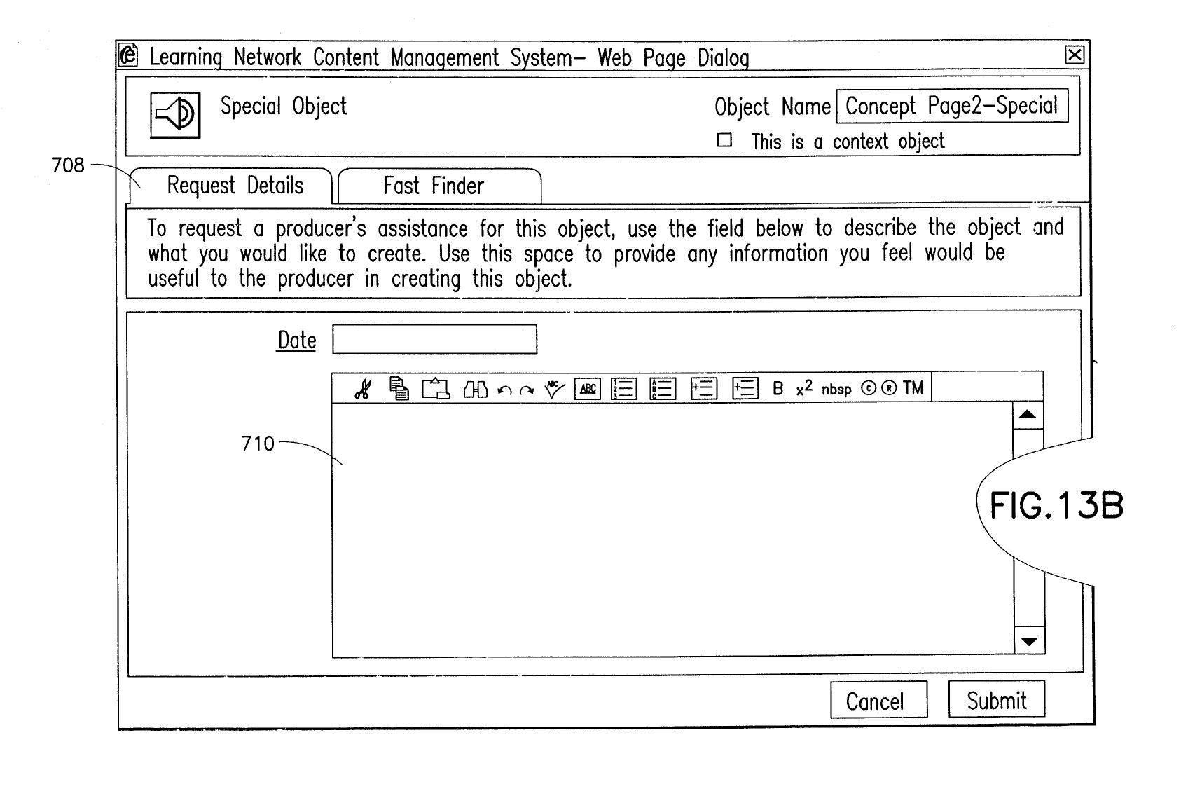

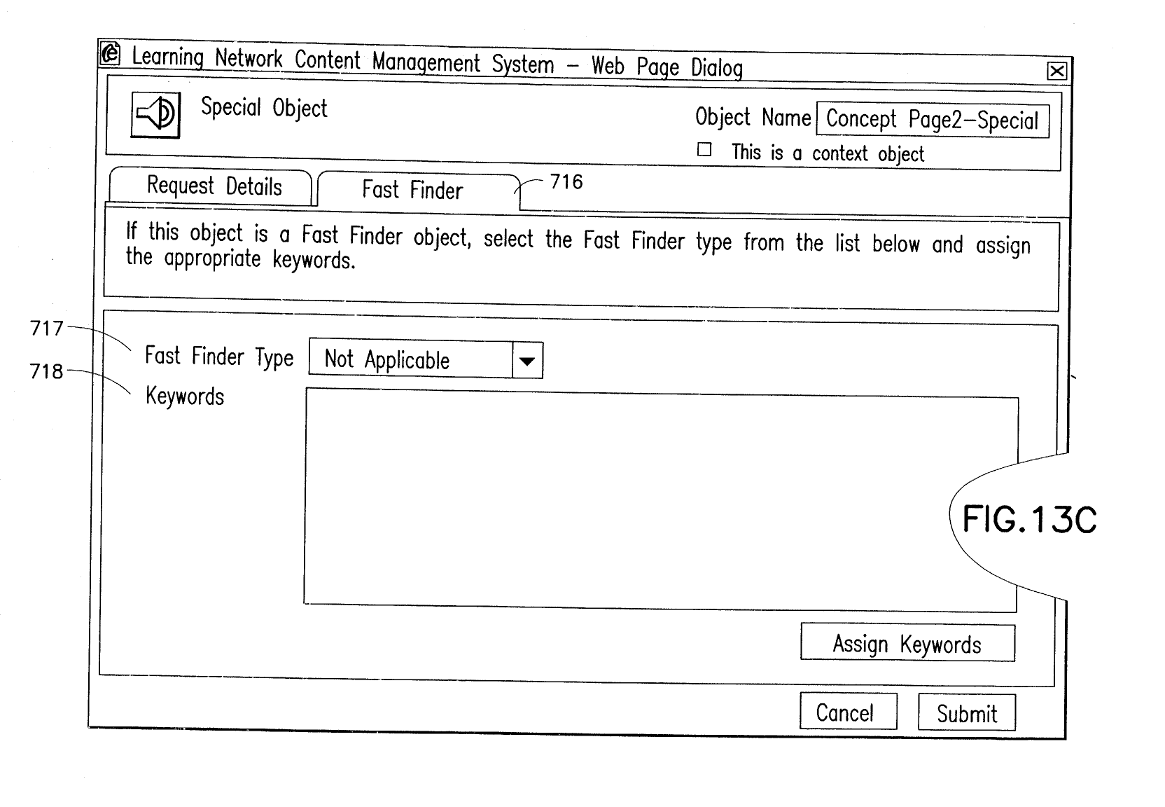

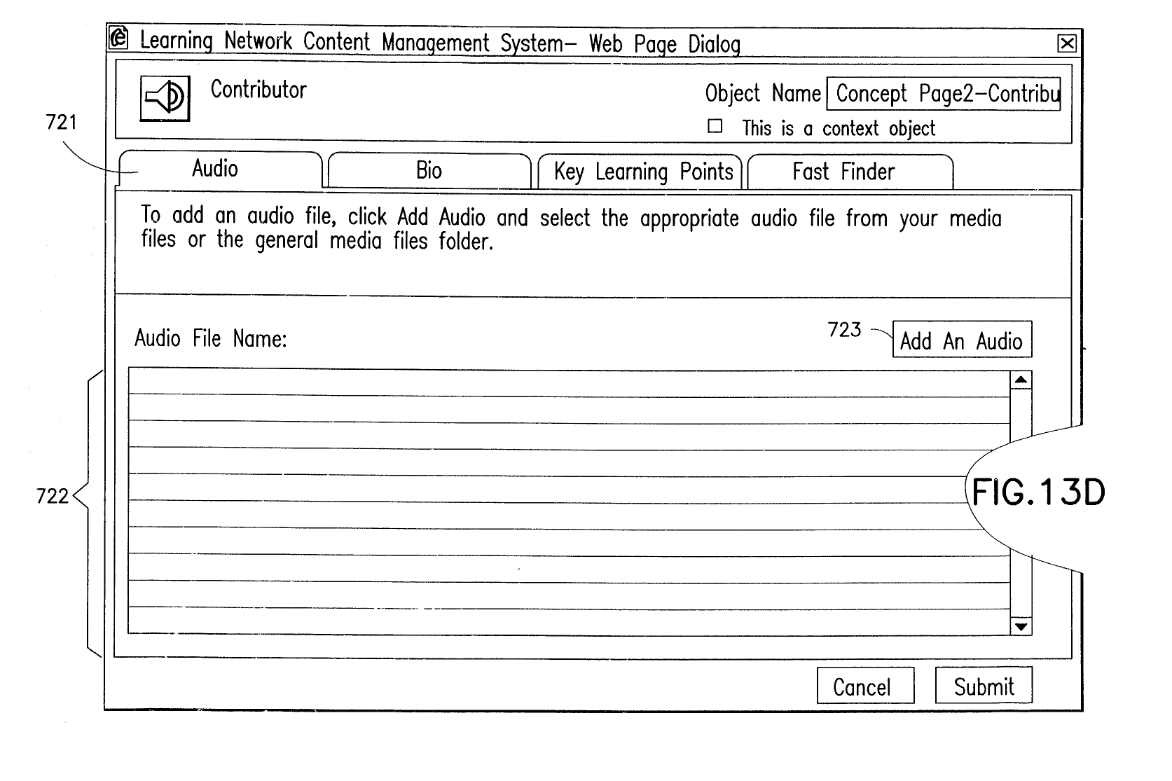

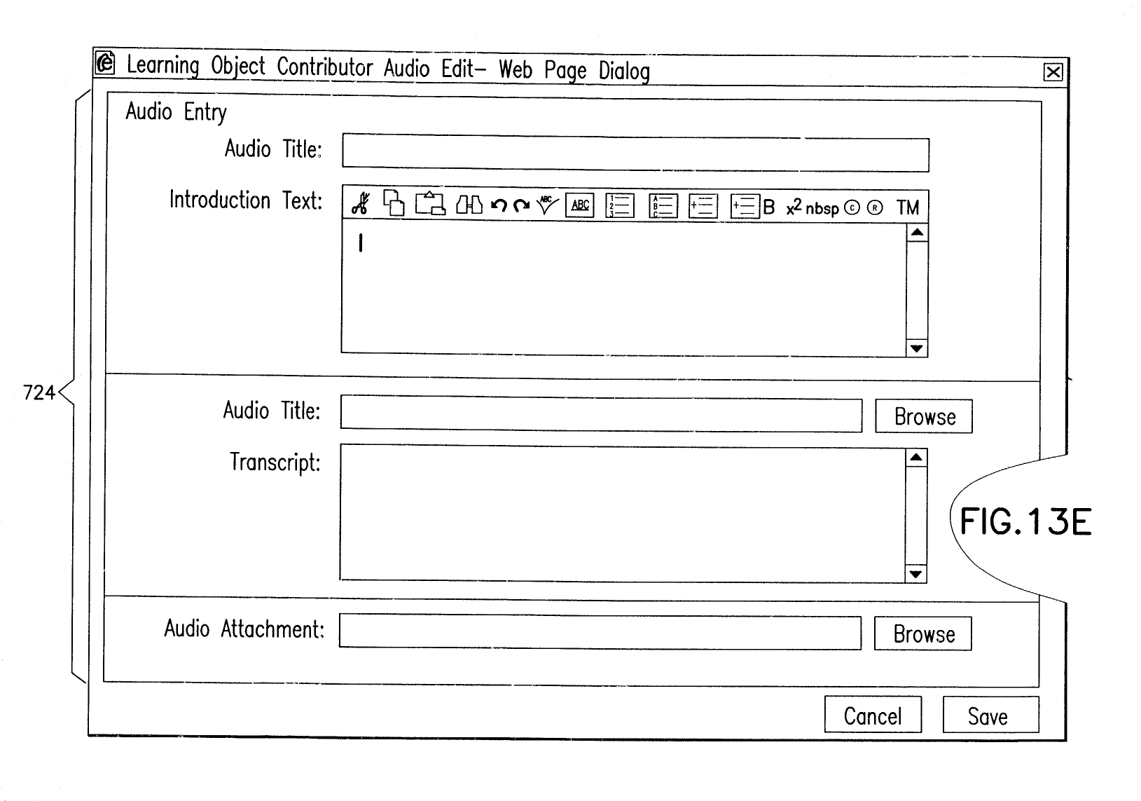

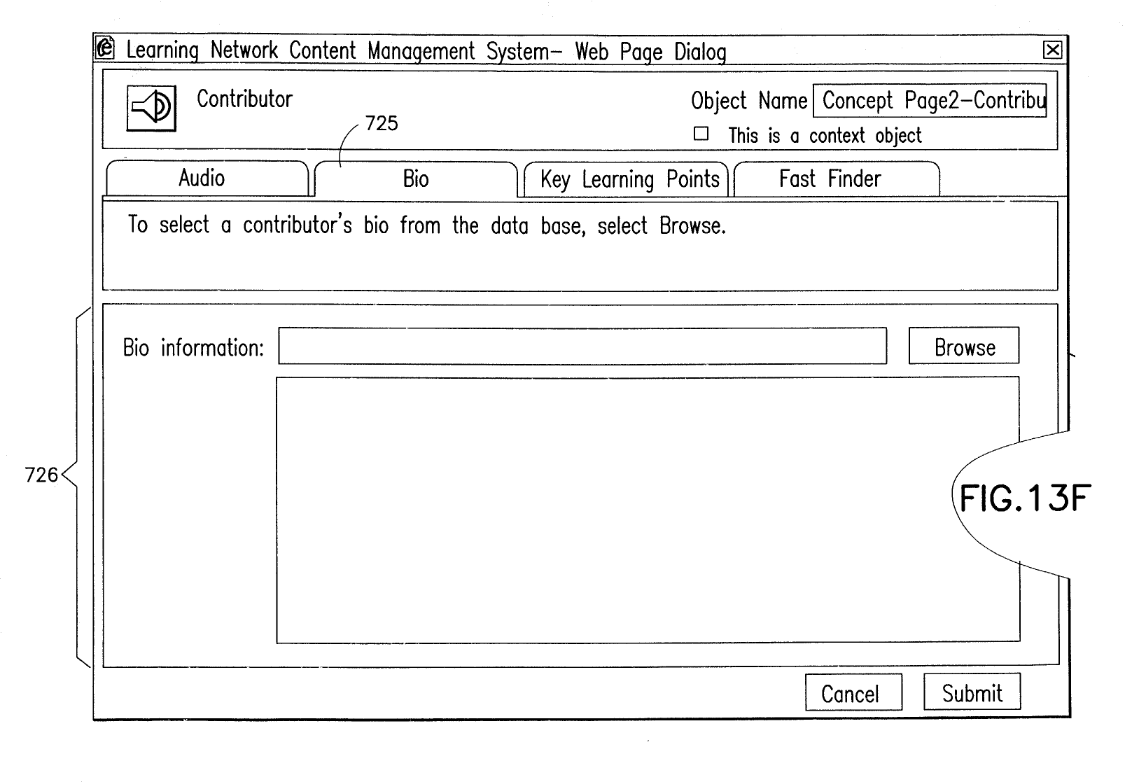

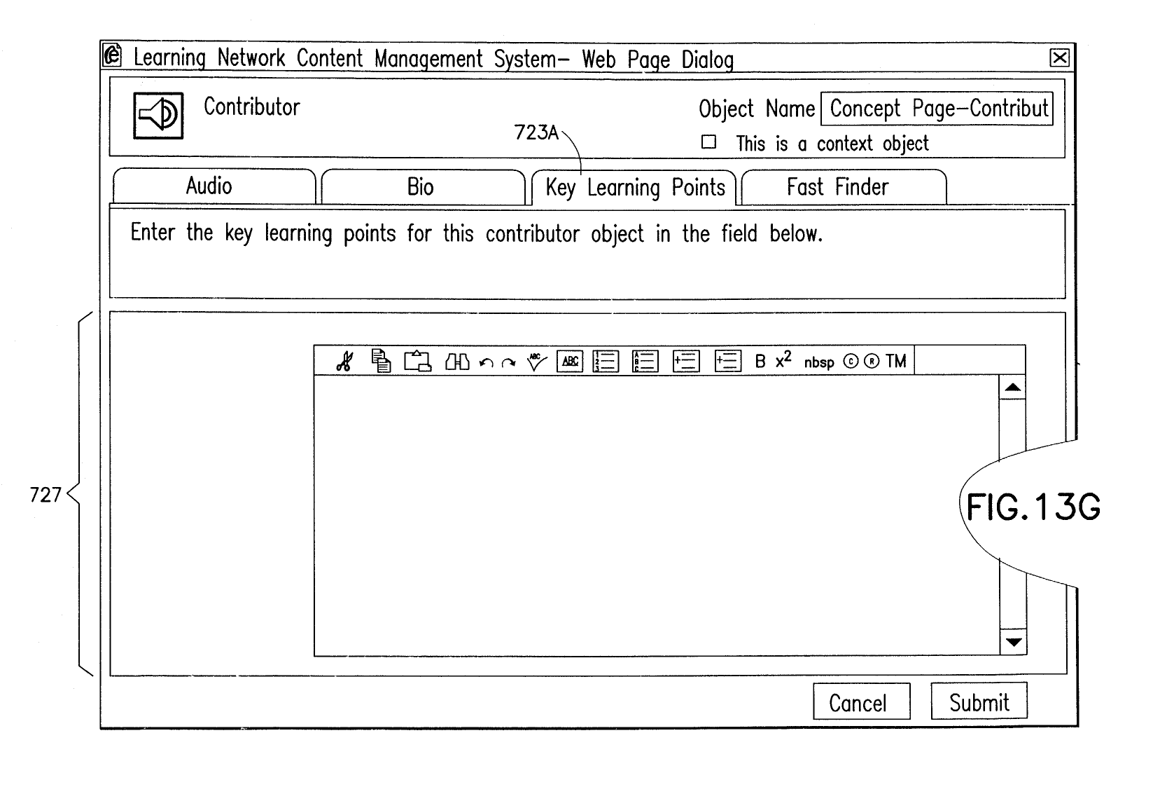

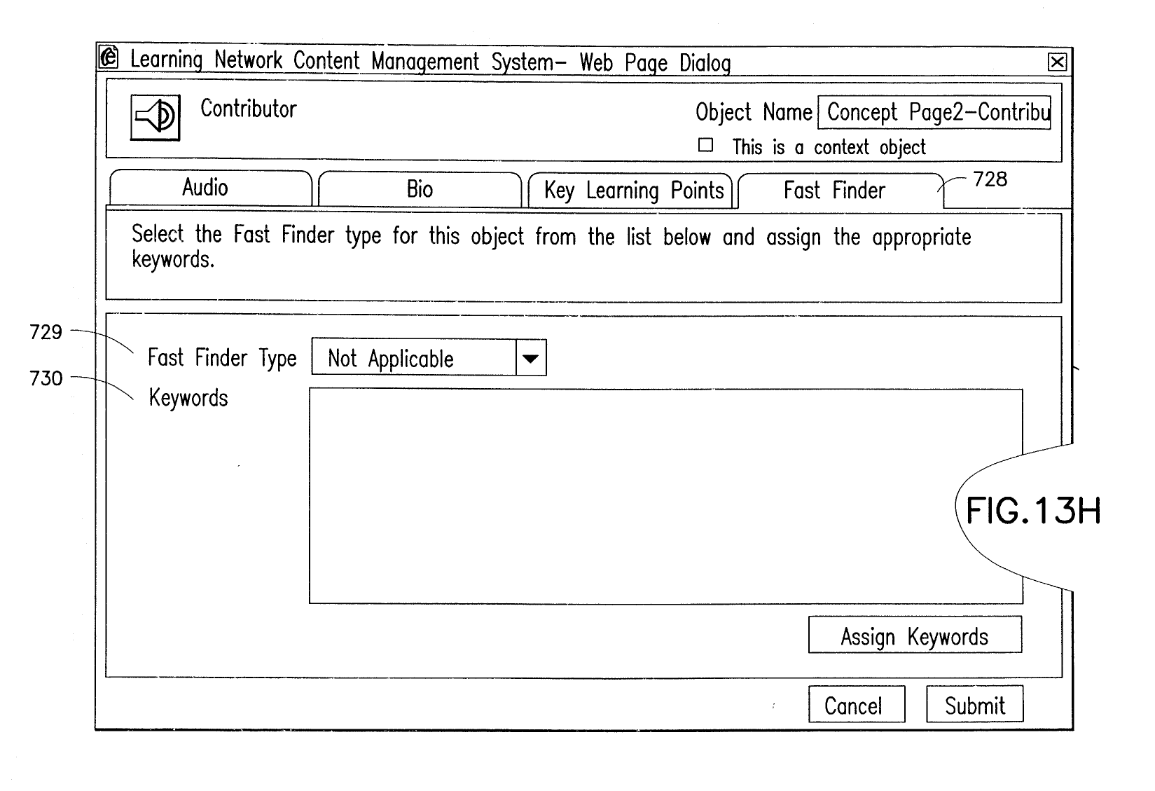

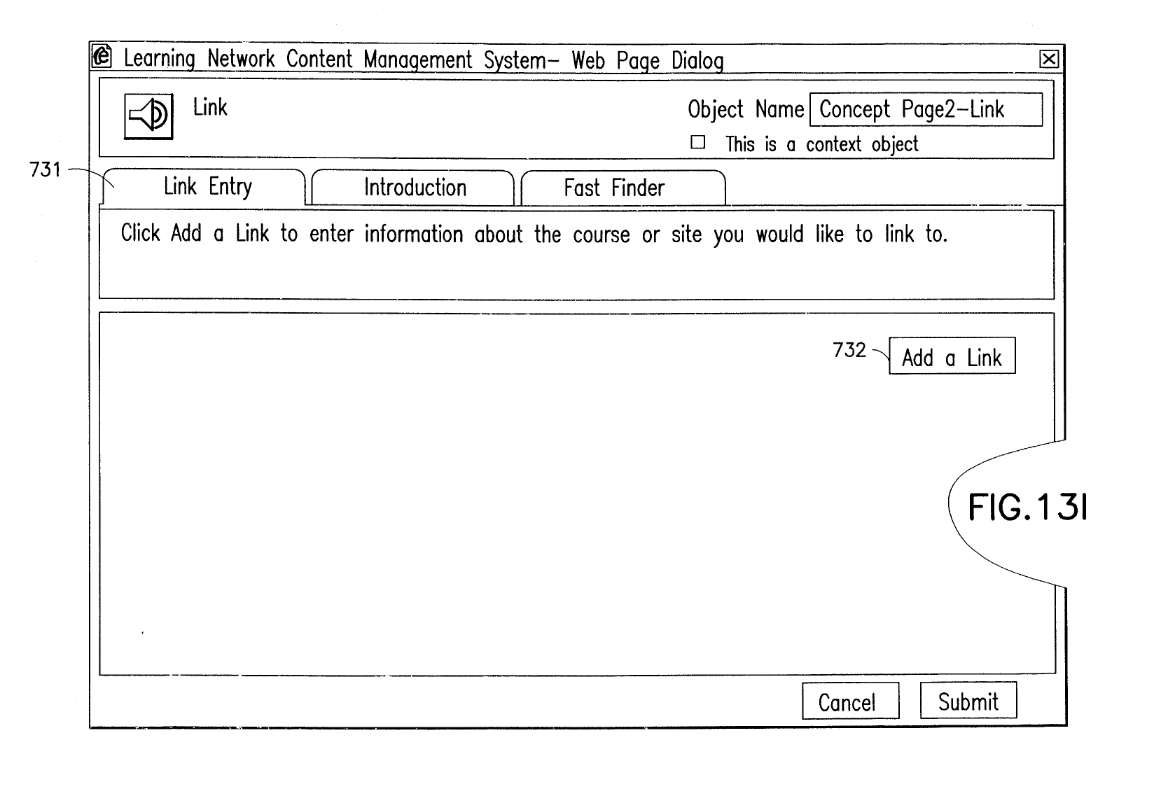

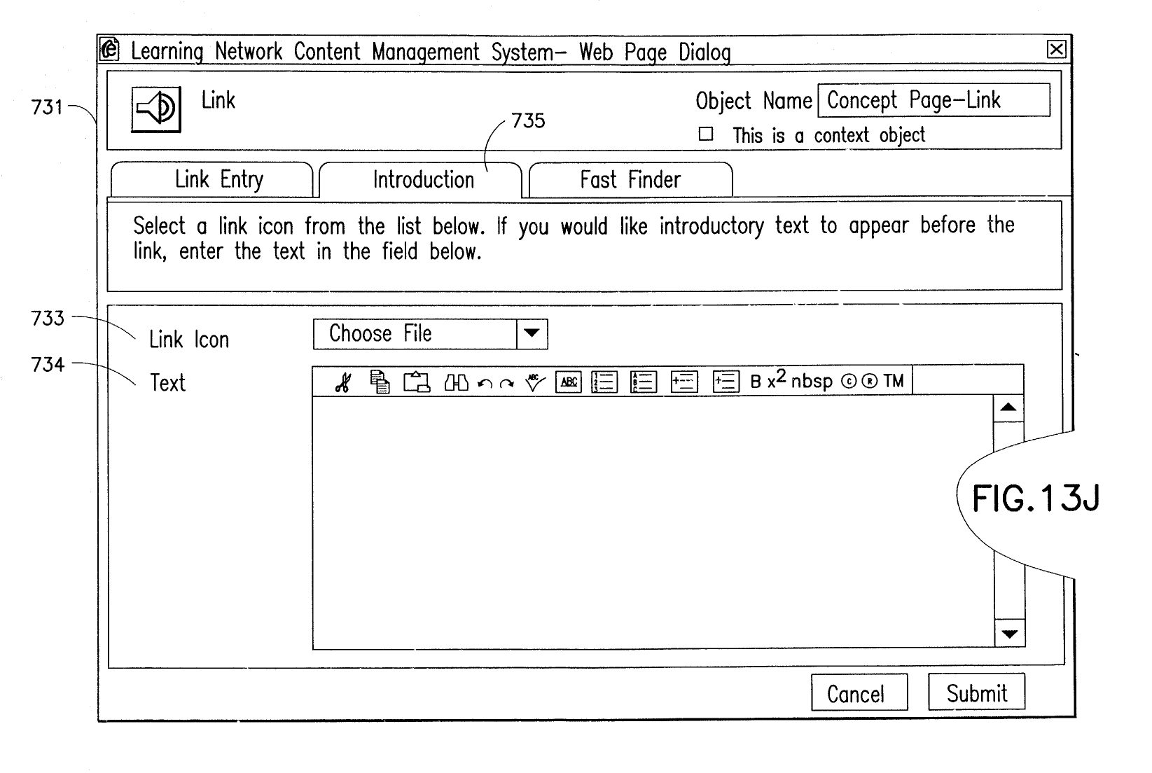

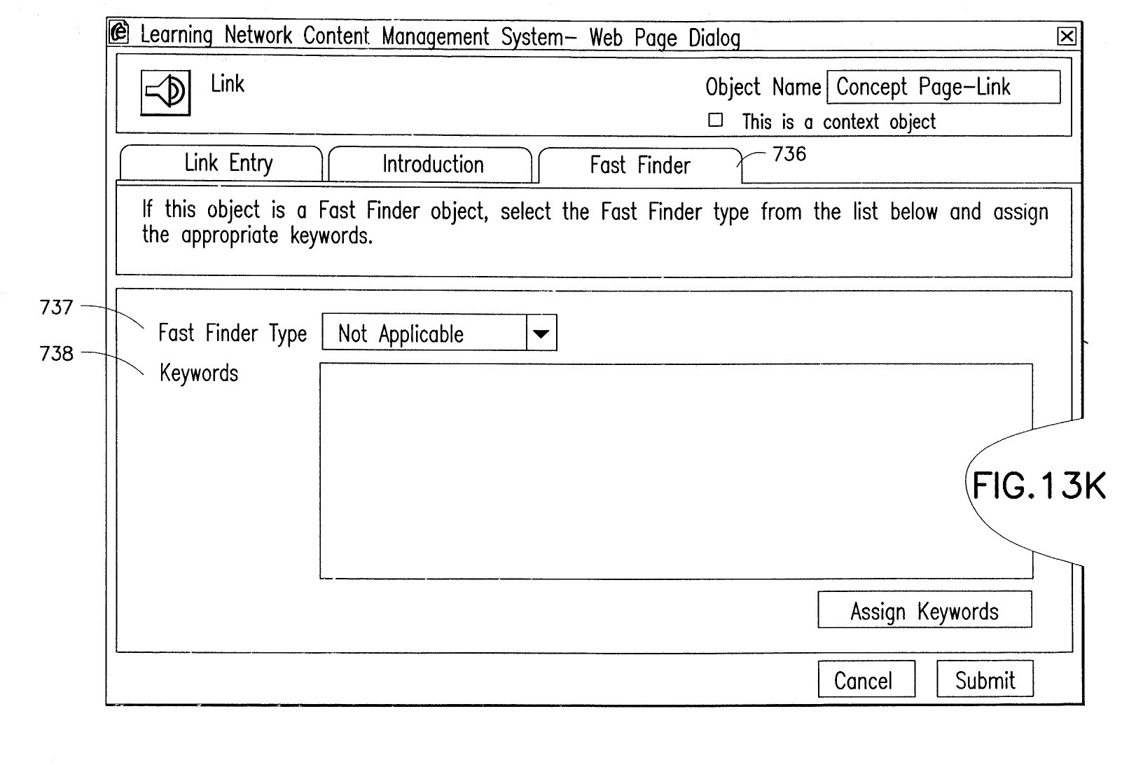

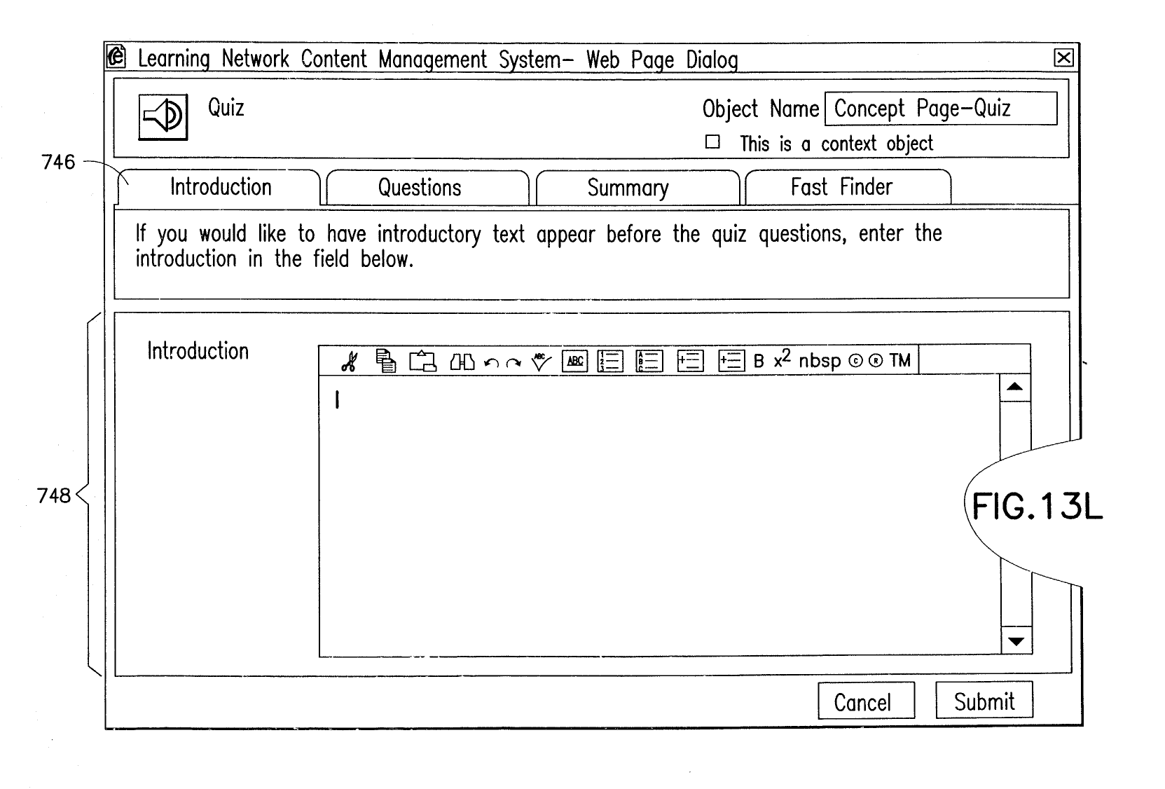

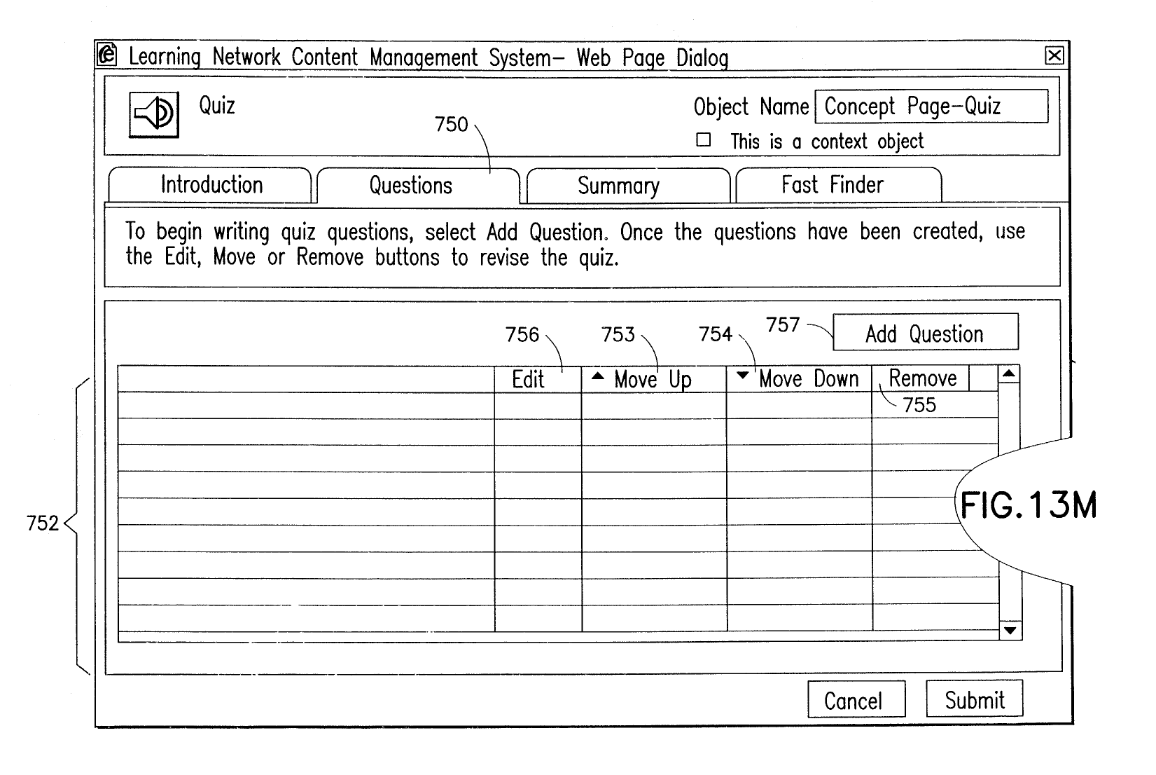

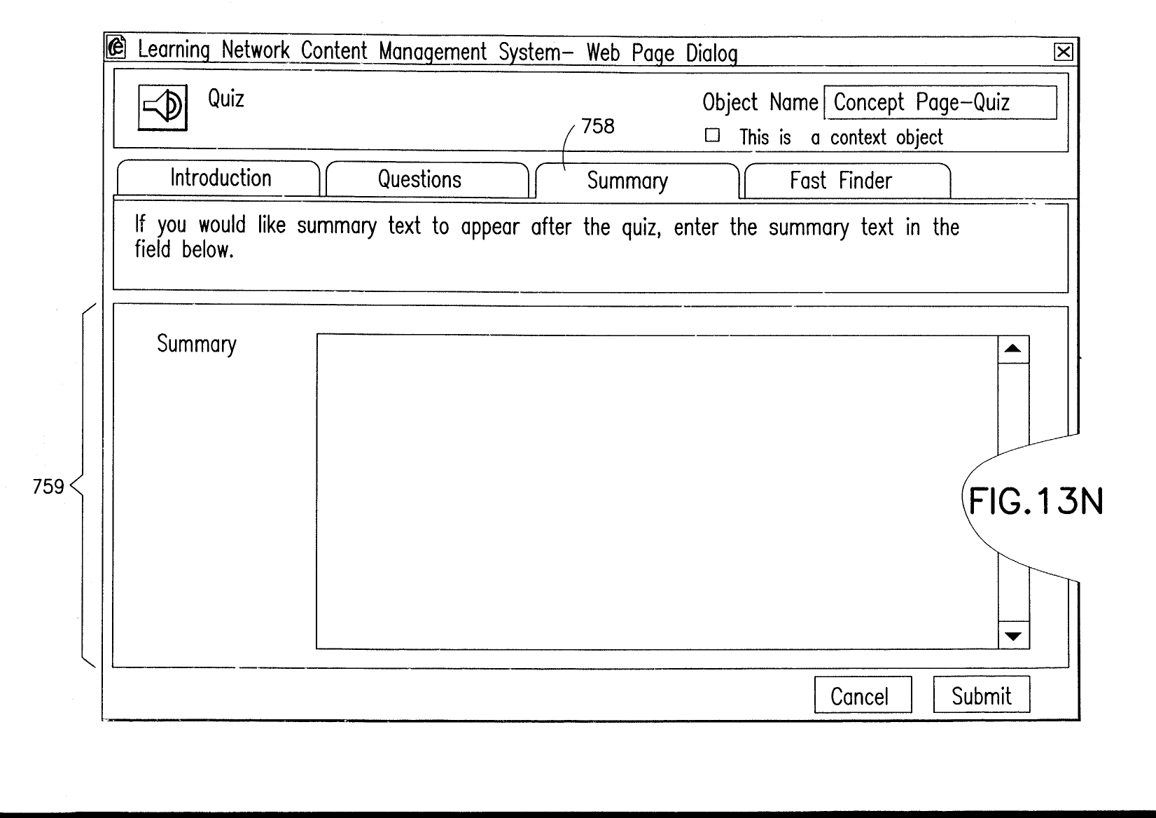

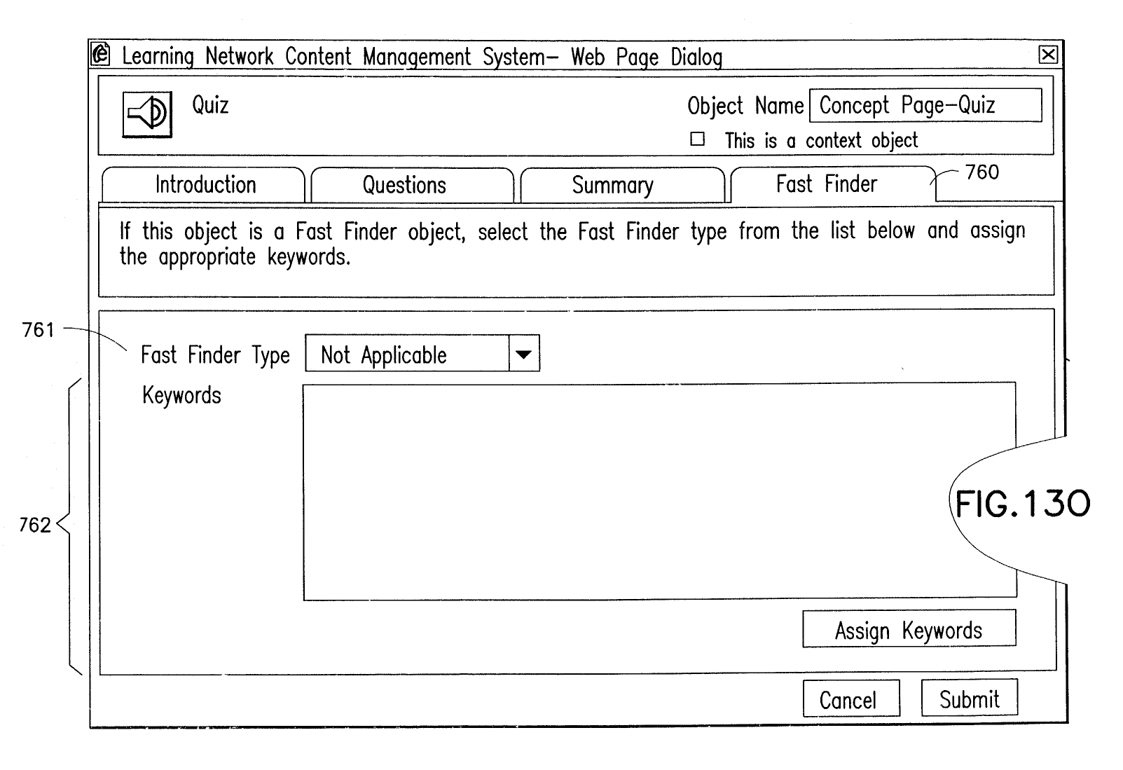

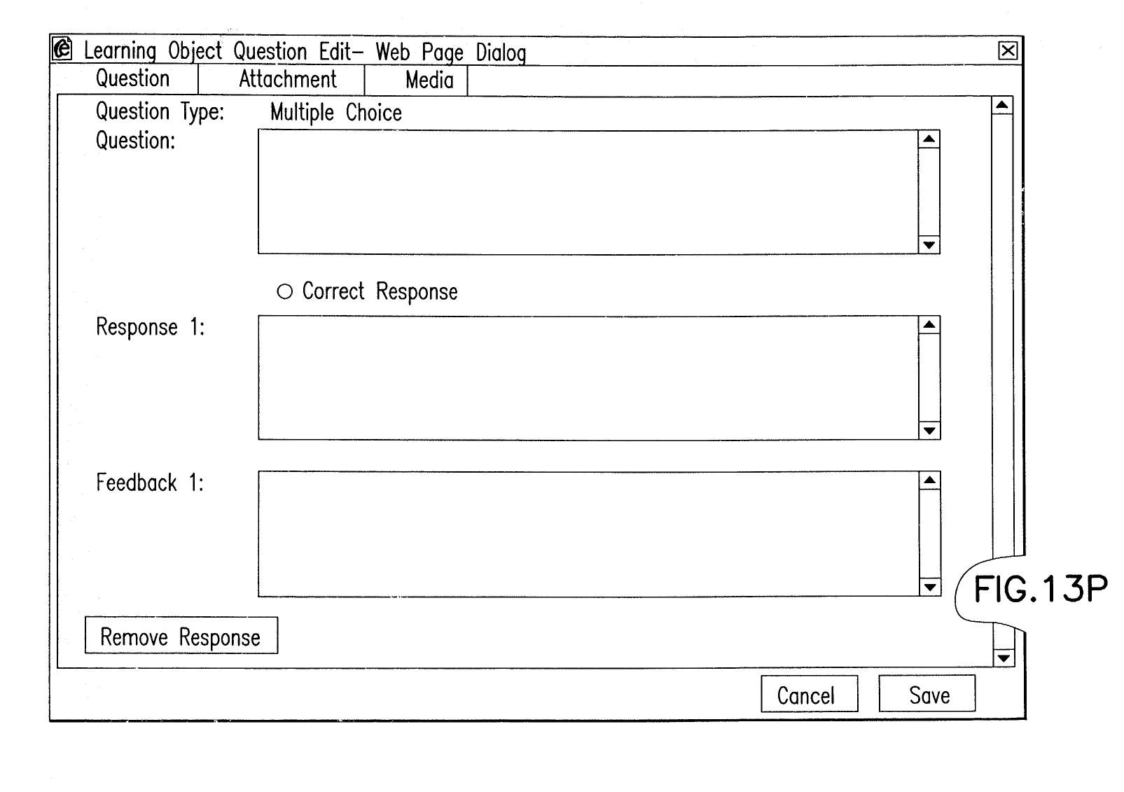

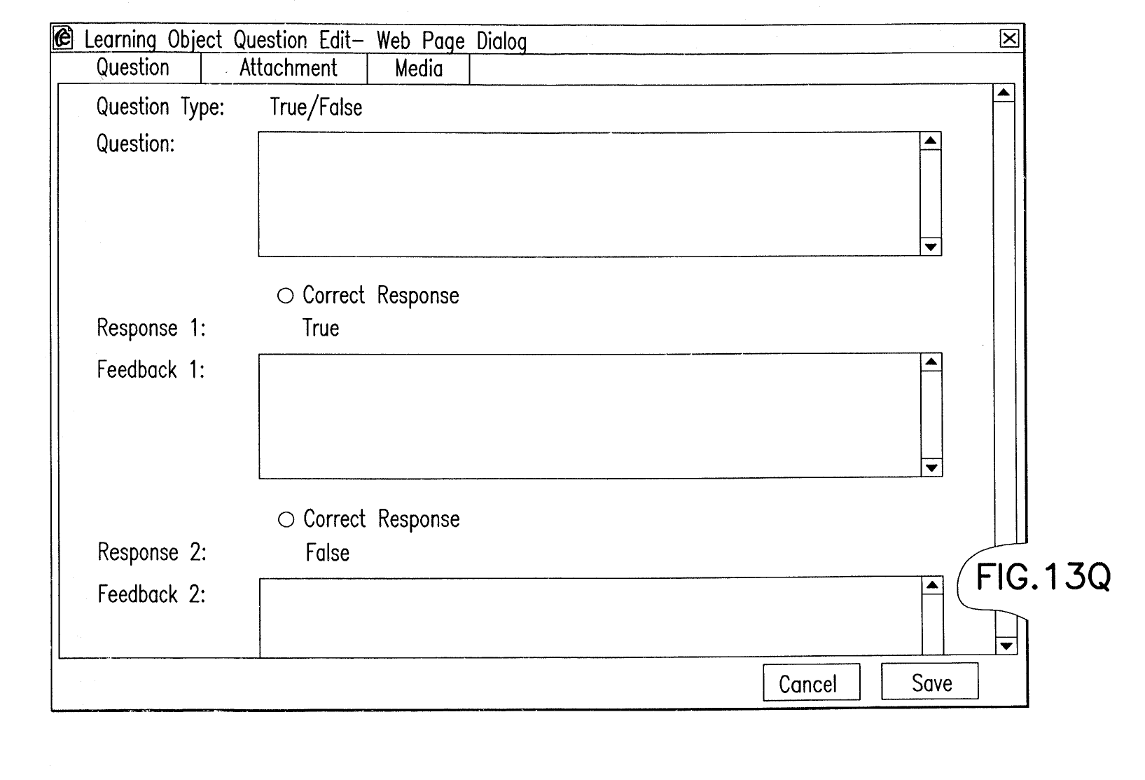

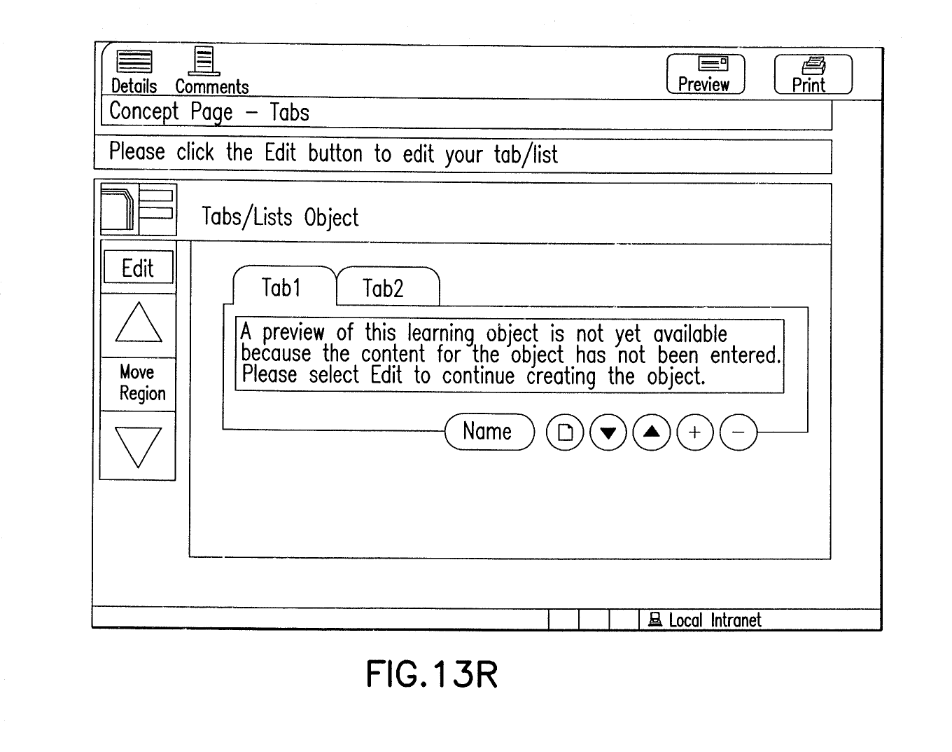

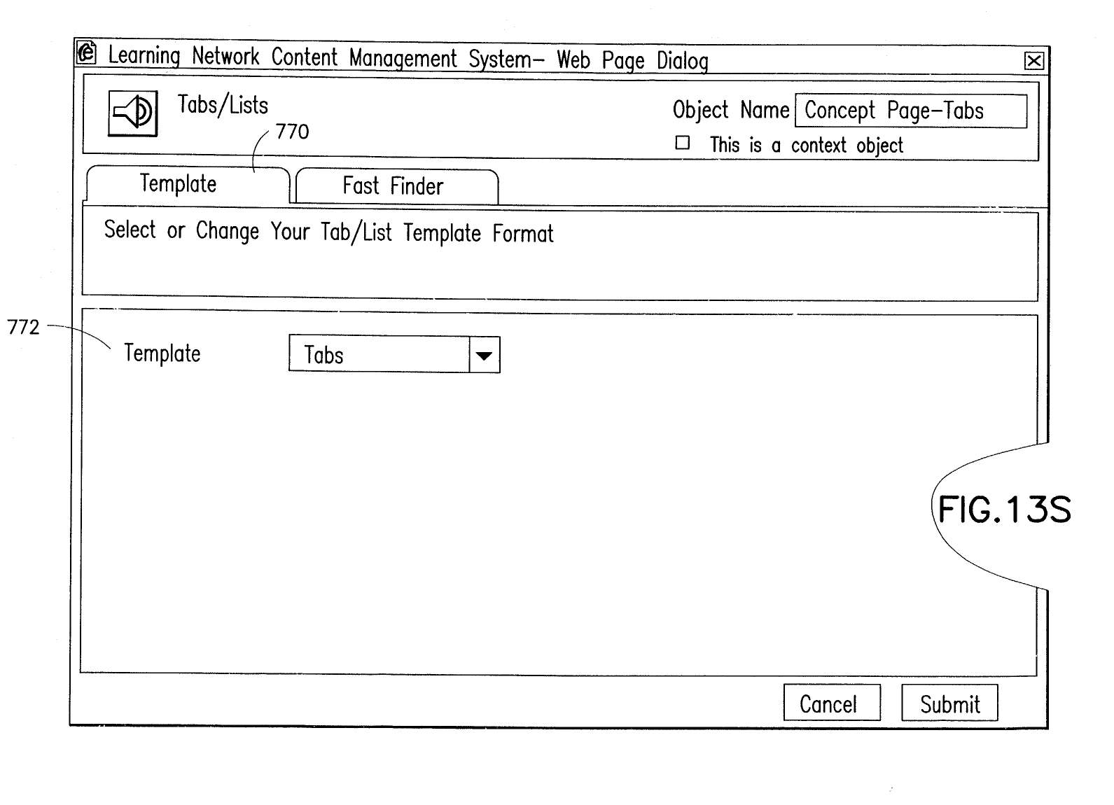

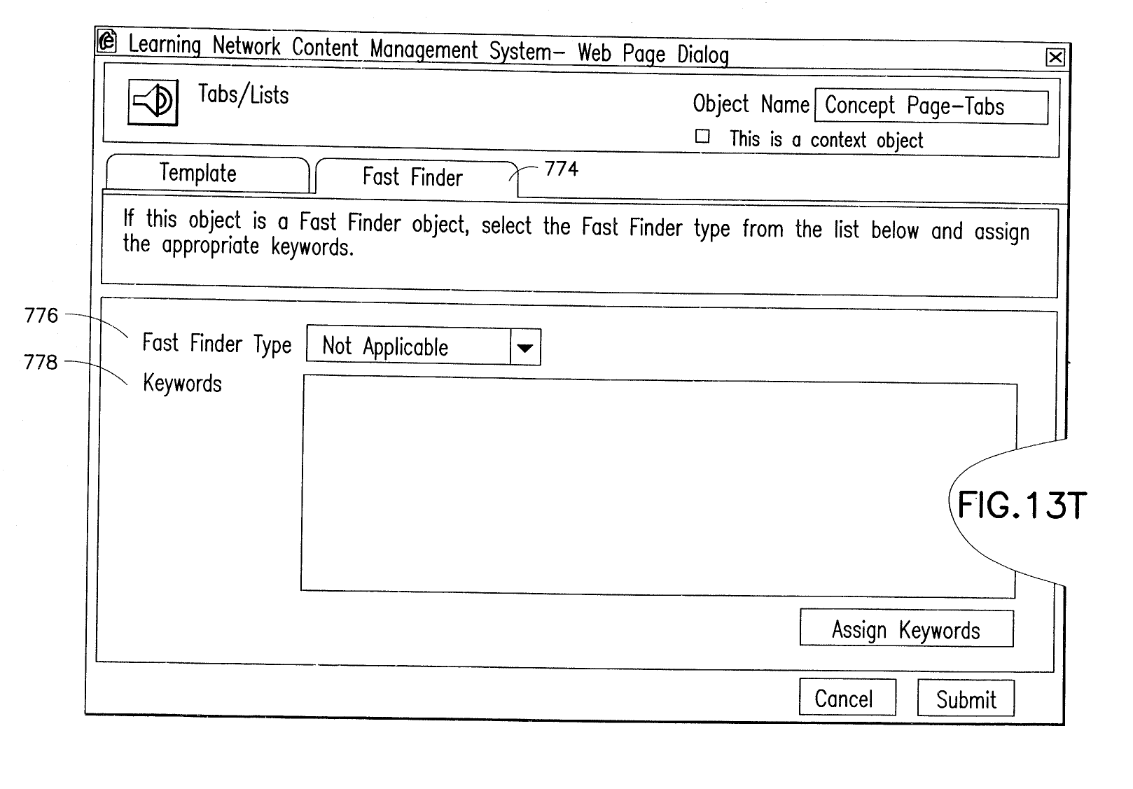

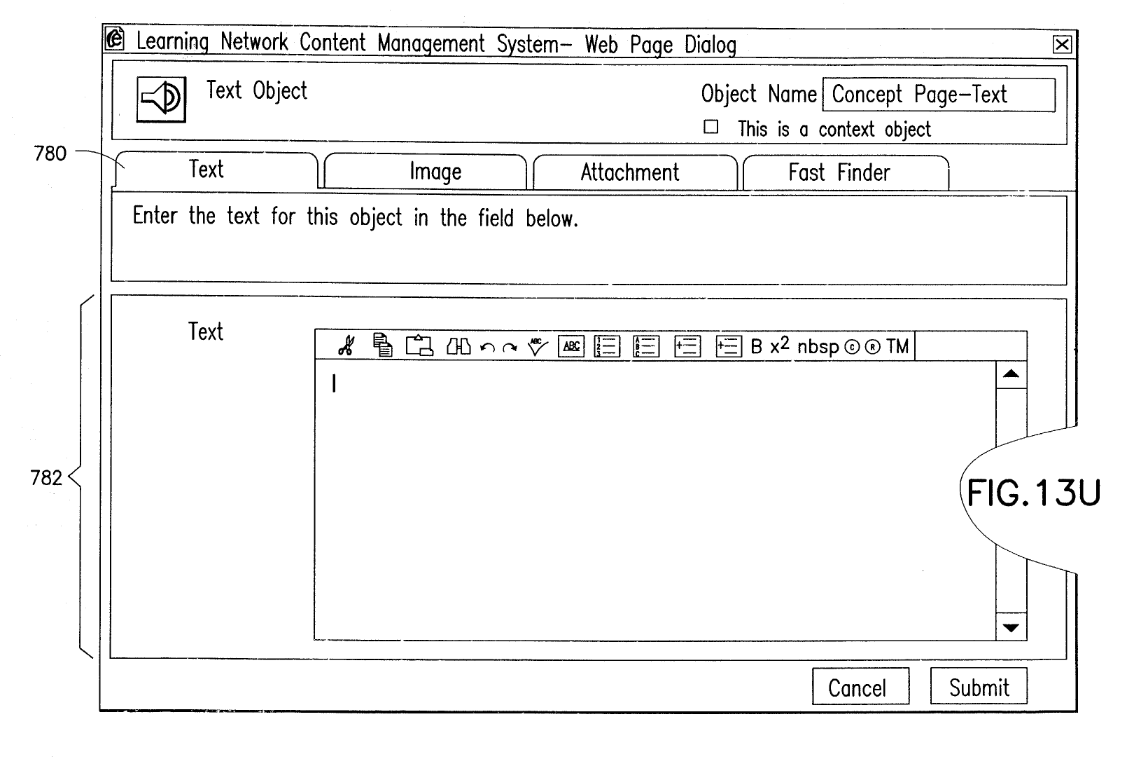

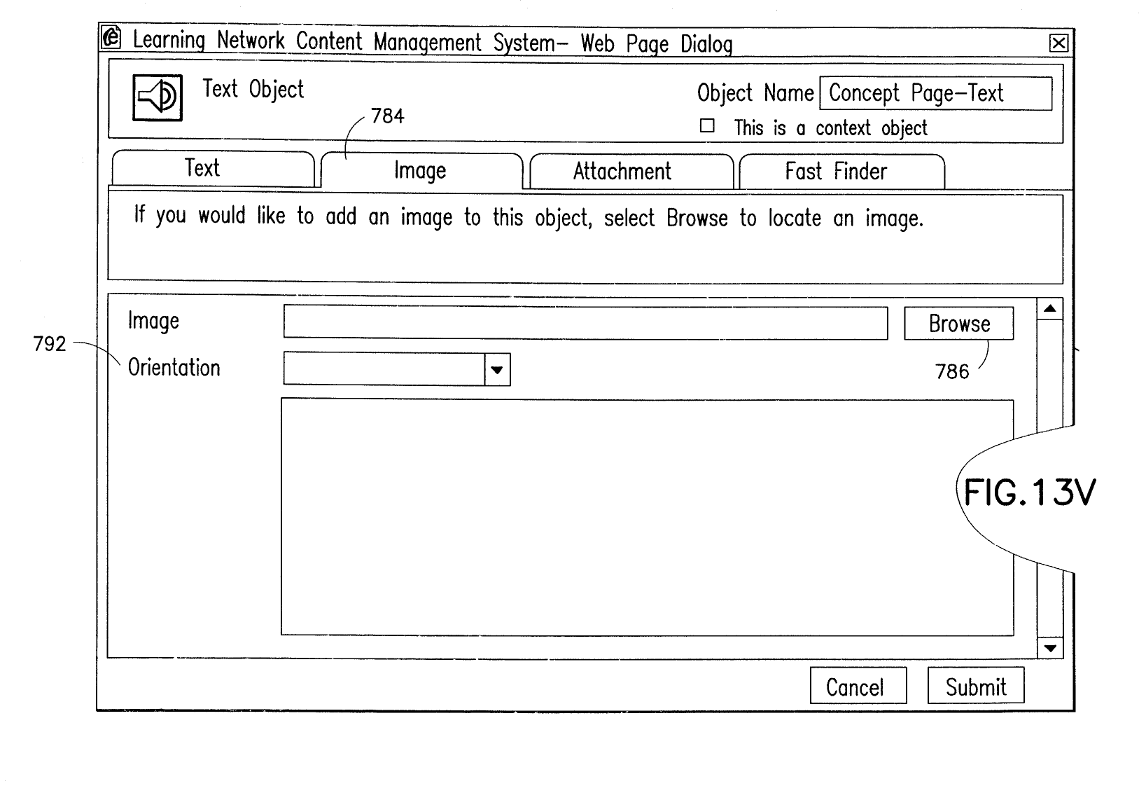

As discussed with reference to FIG. 2, there are, for example, six types of Learning Objects (Special, Text, Contributor, Quiz, Link and Tab/Lists). To create a new Learning Object, the user selects the type of Learning Object he would like to create and enters the content of the Learning Object (step 154). FIG. 13A shows an embodiment of a representative Learning Object type selection page 700. As shown in FIG. 13A, the Learning Object type selection page 700 provides a list of types of Learning Objects 702 that can be selected. The right side of the screen display 704 shows a selected Text Learning Object as it would appear to a person taking the course. Embodiments of representative screen displays used to enter content for each of the Learning Objects are shown in FIGS. 13B-13X.

A Learning Object Special Page, as shown in FIGS. 13B and 13C, allow a user to add to the course a Learning Object that is unique and programmed into the system. To create a Learning Object, a user may request assistance from a software developer by selecting the Request Details button 708 and entering information on the right-side of the screen describing the Special Learning Object to be created 710. The user may enter the type 717 of Special Learning Object and keywords 718 to be assigned to this object so that other users can find this object using the search function.

A Contributor Learning Object Page, as shown in FIGS. 13D-13H, allows a user to add a Learning Object presented by an expert in the subject matter of the course. The information presented can be in form of a quote, an audio file, a written piece of Text or a combination of all these things. By clicking on the Audio button 721, the user can access the screen display of FIG. 13D. In FIG. 13D, there is a field 722 for audio files. By clicking on the Add an Audio button 723, the user can access the screen display of FIG. 13E, which contains fields 724 to enable users to find and add a Contributor Learning Object to the course. By clicking on the Bio button 725, the user can access the screen display of FIG. 13F which contains fields 726 for entry of background information about the expert. By clicking on the Key Learning Points button 723, the user can access the display of FIG. 13G which contains a field 727 for entry of important points for a Contributor Learning Object. By clicking on the Fast Finder button 728, the user can access screen display of FIG. 13H which contains fields for entry of a Fast Finder Type 729 and Keywords 730 to enable other users to find the Contributor Learning Object using the search function.

A Link Learning Object Page, as shown in FIGS. 13I-13K, allows the user to add to the course a Link to other materials. Using the Link Learning Object, the user may Link to “external” (outside the system application) information or “internal” (inside the system application) information. To add a link, the user clicks on the Link Entry 731 and Add a Link buttons 732. By clicking on the Introduction button 735, the user can select a Link icon 733 and/or text to display before the link 734. Finally, by clicking on the Fast Finder button 736, the user may assign a Fast Finder Type 737 and keywords 738 to enable other users to find the Link Learning Object using the search function.

A Quiz Learning Object Page, as shown in FIGS. 13L-13Q, can be used to create an assessment that tests the learner on specific content. Using the Quiz Learning Object, the author can create the format for the questions (e.g. multiple choice or true/false questions, yes/no or Text questions). By clicking on the Introduction button 746, the author can access the screen display of FIG. 13L which contains a field for the entry of Introductory Text 748. By clicking on Questions button 750, the user can access the screen display of FIG. 13M which contains fields 752 for entry of questions and to organize the questions by moving a question up 753 or down 754, to remove a question 755 or edit a question 756. To create a new question, the user can click on the Add Question button 757 which will enable the user to access screen displays 13P and 13Q. Entry of information in the fields of those screen displays (i.e. questions and responses, e.g. multiple choice and true false) enables the user to create a Quiz Learning Object. By clicking on the Summary button 758, the user can access the screen display of FIG. 13N which contains a field 759 for the entry of summary text that appears after a quiz. Finally, by clicking on the Fast Finder button 760, the user can access the screen display of FIG. 13O which contains fields for the entry of a Fast Finder type 761 and keywords 762 to enable other users to find the Learning Object using the search function.

A Tab/Lists Learning Object Page, as shown in FIGS. 13R-13T, can be used to create tabs, an expandable list, or a left to right list. By clicking on the Template button 770, the author may select the template 772, e.g. as tabs or as an expandable list or as a left-to-right list, that formats how the information will be presented to the user. By clicking on the Fast Finder button 794, the author may also set up the fast finder type 776 and the keywords 778 to be associated with the Tab Learning Object for searching purposes.

A Text Learning Object Page, as shown in FIGS. 13U-13X, can be used to create content that would be placed on a Concept Page for a course. These objects can include text, images, attachments and quotes pulled together to convey a single idea. Using a the Text Learning Object Page, the author can click on the Text button 780 to access the screen display of FIG. 13U and enter text at field 782, can click on the Image button 784 to access the screen display of FIG. 13V and select an image using a browse function 786 and can click on the Attachment button 788 to access the screen display of FIG. 13W and select an attachment using a browse function 790. With respect to the selection of an image, the user can also select an orientation 792 to facilitate where the content will be positioned in respect to the text. To enable other users to find the Text Learning Object using the search function, the user can click on the Fast Finder button 794 to access the screen display of FIG. 13X to enter a Fast Finder type 796 and keywords 798.

Returning to FIG. 4B, having created course content, a user may choose to continue building the course (step 156). If the user decides to continue building the course, the process of creating course content restarts. A user may also choose to classify the content or components thereof (step 158) to facilitate locating of the content by other users using the search function.

A Classify Page allows the author to classify a given object. There are a number of factors by which the object can be classified including, for example, competency level, delivery type, instructional type, source and regions/country. These classifications allow content to be categorized so that users can search for content based on these defined categories using the search function (see FIG. 7B at 548, 550, 552, 554 and 556). In addition, a Classify-Batch Page allows the author to classify a group of objects from a current course and apply a single classification to the grouping. This differs from the Classify Page Function which only allows the author to classify one object at a time. By categorizing objects and classifying them as a group, users can easily search for these objects in the system by using the defined categories (see FIG. 7B at 548, 550, 552, 554 and 556).

As shown in FIG. 4B, the user can periodically update its workflow description to account for projects that have been completed or taken to another stage (step 160). A Workflow Details Page allows the author to indicate stages that he has completed in the development of a project. The Workflow Details Page can include, for example, completion of assembly, editing, quality assurance review and publication of a particular component of a course step.

Finally, as shown in FIG. 4B, the user can return to the home page (step 162).

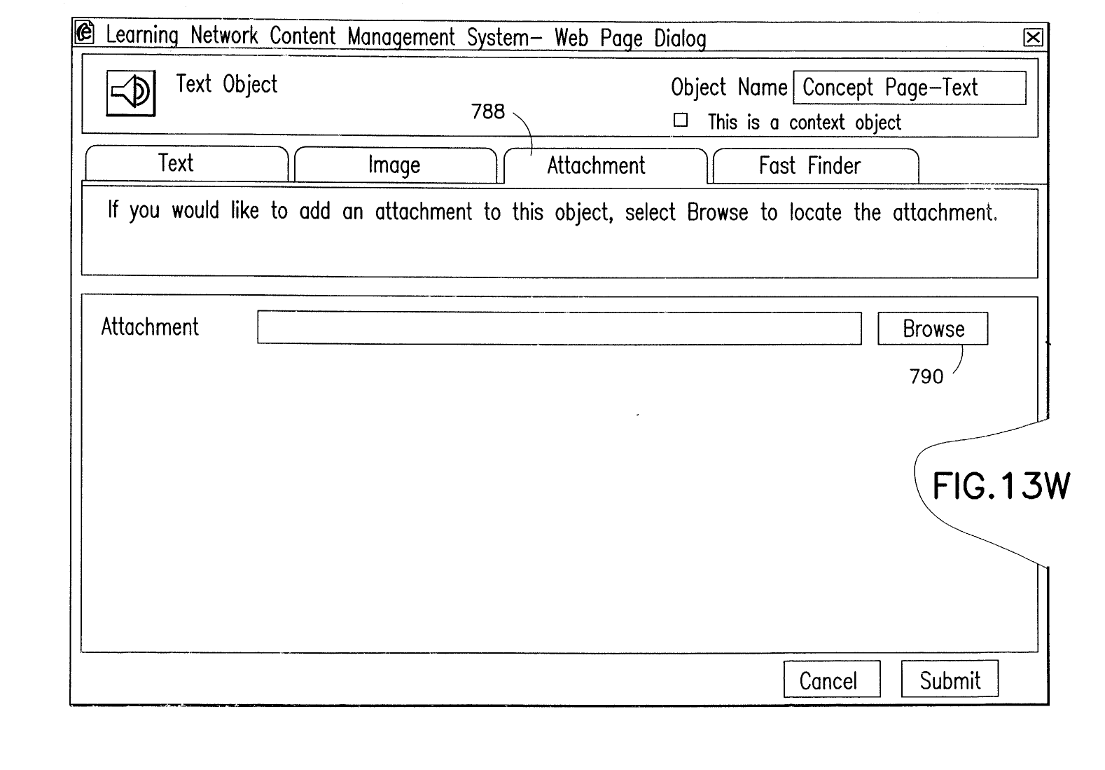

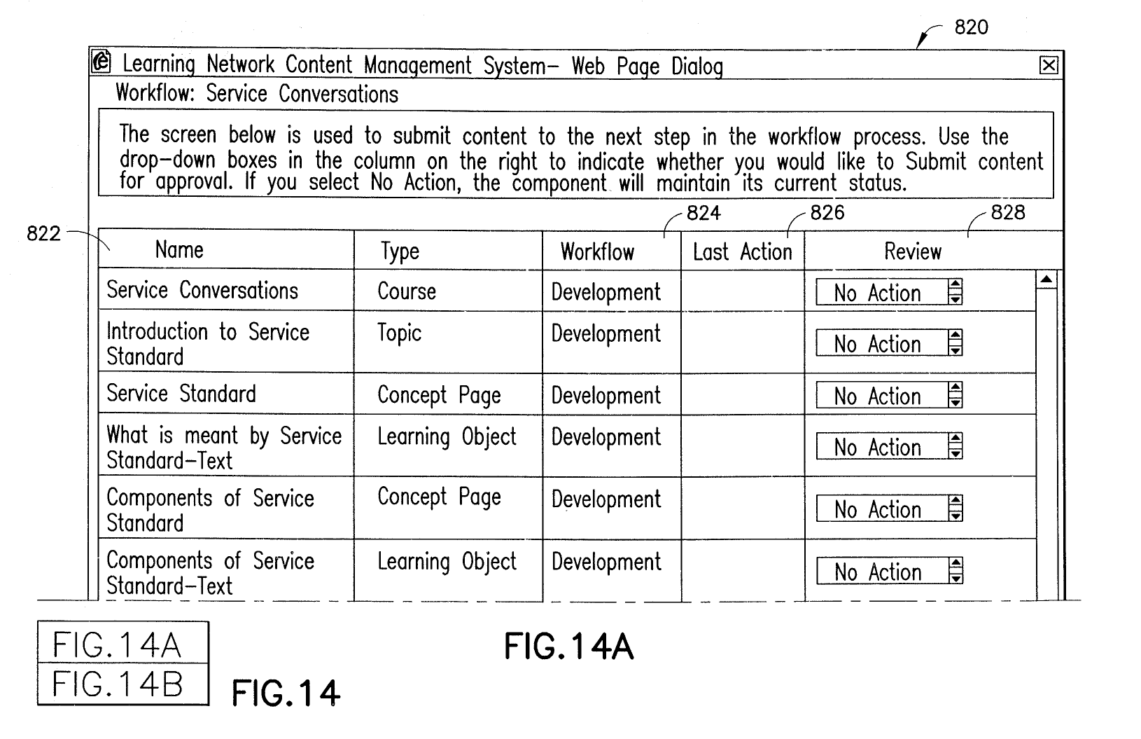

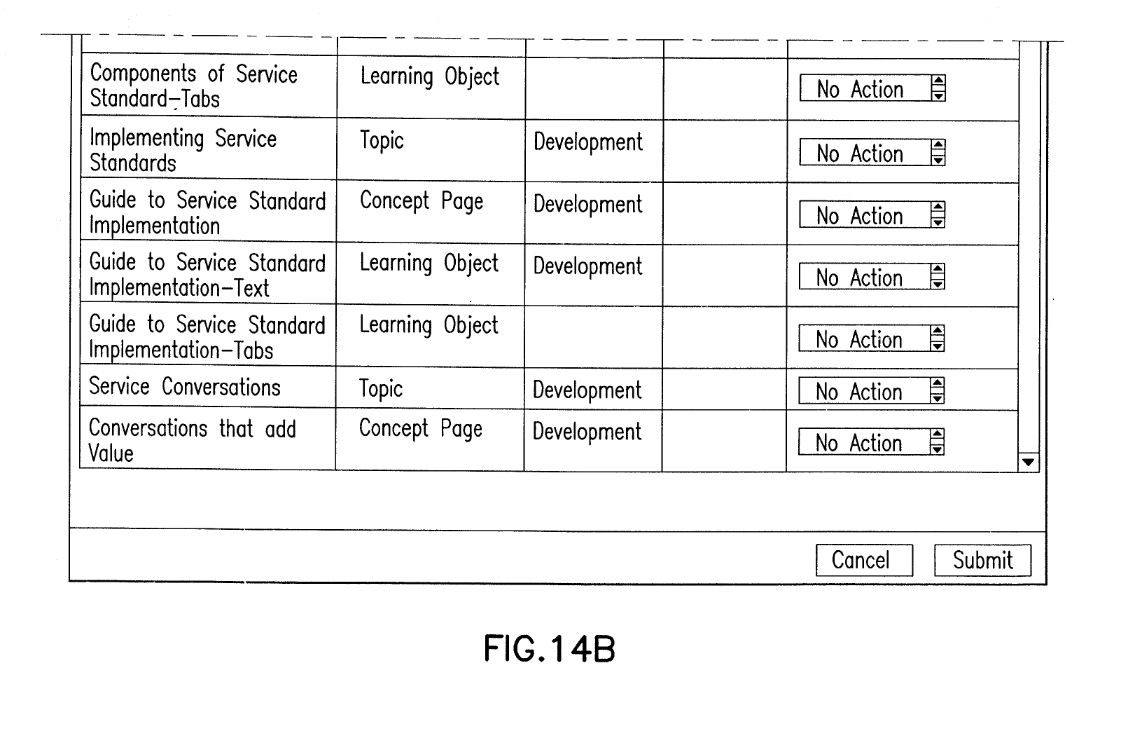

As described with respect to FIG. 2, the workflow on a particular project can be monitored by a number of individuals associated with the project. FIG. 14 is an embodiment of a representative workflow process screen display 820 that would be available to the author of content (see FIG. 2 at 82). As shown in FIG. 14, a number of course components currently in progress by the author and the progress of those course components are indicated. The name of the course components 822, the workflow status 824 and the last workflow action 826 are reported. In the Review column 828, the author may indicate if content if ready to be submitted for approval by selecting the appropriate choice in the drop down list. In addition, pages can be made available for an administrator (described below) to monitor the status of the workflow and approve or disapprove of the content that has been developed (see FIG. 2 at 94).

5. Administrative Function

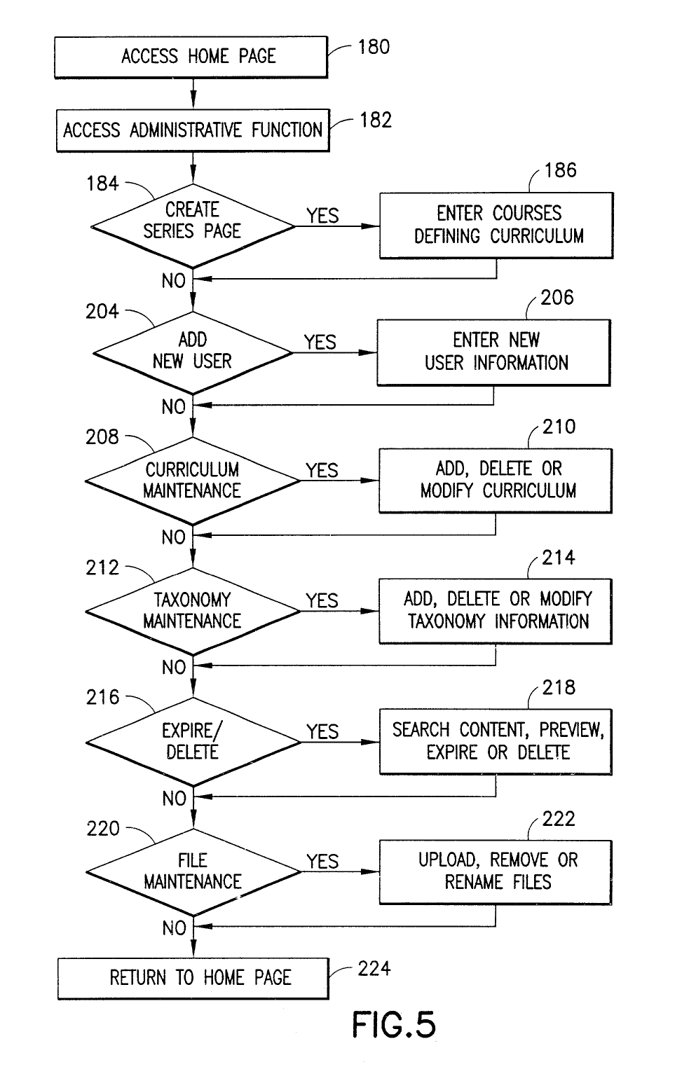

FIG. 5 is a flow diagram showing an embodiment of a representative administration process for use in the system and method. As shown in FIG. 5, an administrator of the system, with access to the system home page shown in FIG. 6 (step 180), can further access an administrative functions (step 182). These administrative functions are only available to authorized persons. An administrator also has access to all of the user functions previously described.

The administrative functions provide an administrator with a view of the work for a curriculum (this includes projects in all phases of development) and can be sorted to allow the administrator to view the information in several different ways. As shown in FIG. 6, an administrator has a number of buttons available to facilitate administration of the system including, for example, the Users 850, Curriculum 852, Taxonomy 854, Search/Expire 856 and Files 858 buttons.

As shown in FIG. 5, using the administrative functions of the system, an administrator can create a Series Page (step 184) and enter courses defining a curriculum on the Series Page (step 186).

The administrator can also add a new user (step 204) as shown in FIG. 5. This simply requires clicking on the Users button 850 shown on the home page of FIG. 6 to access to a New User Page and entry of the new user's name and role (e.g. author or administrator) (step 206).

As shown in FIG. 5, the administrator can also perform curriculum maintenance (step 208). By clicking on the Curriculum button 852 shown on the home page of FIG. 6, a Curriculum Maintenance Page allows the administrator to add, delete or edit curriculum groups (step 210). For example, the administrator can define a curriculum group, access current details for curriculum group and can define or change specific details.

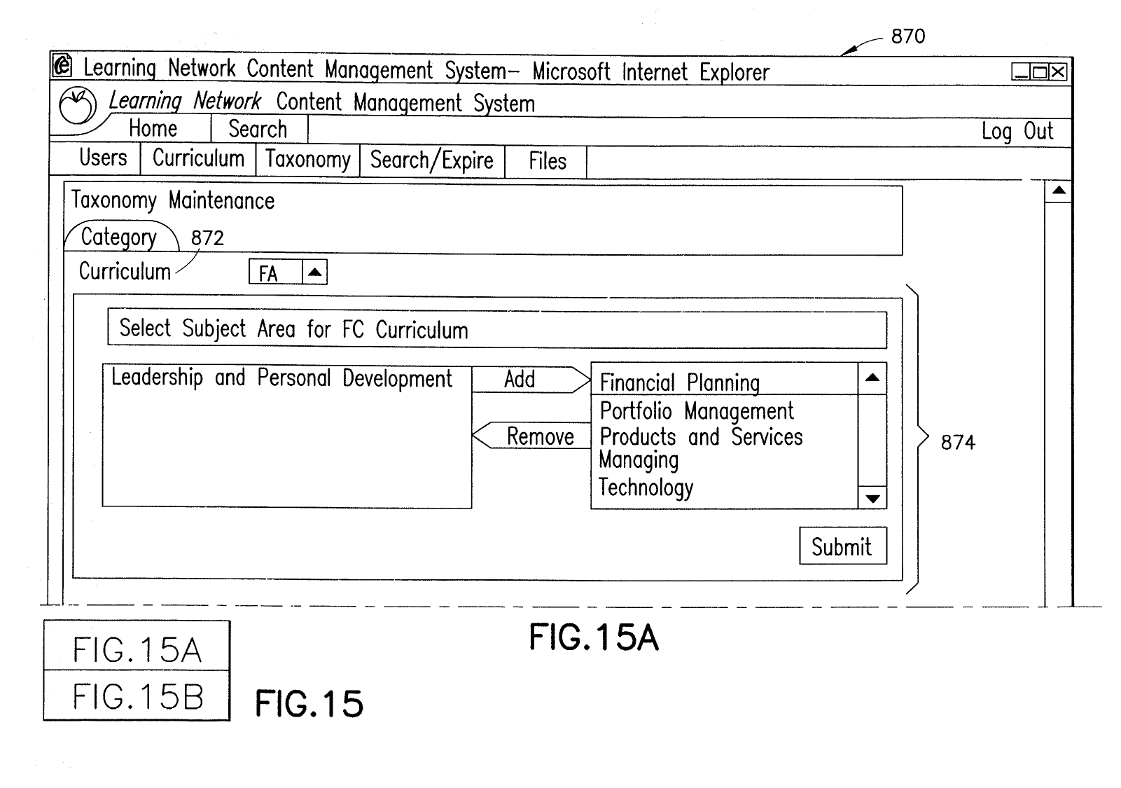

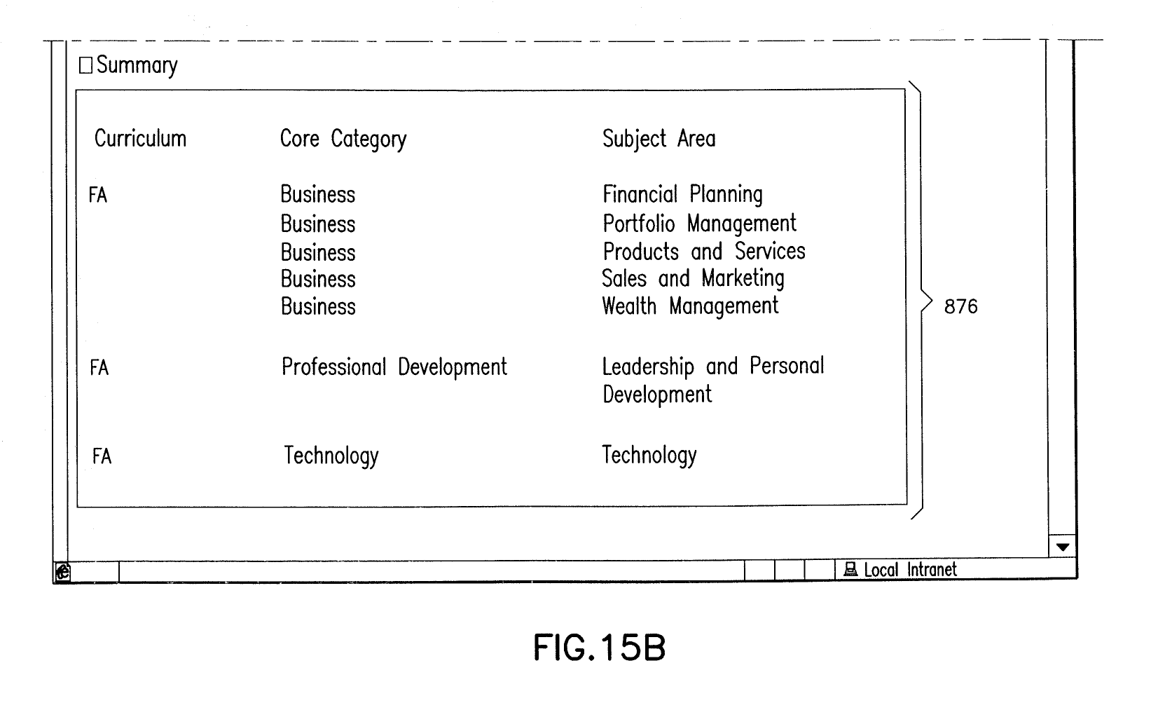

An administrator can also perform taxonomy maintenance (step 212 of FIG. 5). By clicking on the Taxonomy button 854 shown on home page of FIG. 6, the user can access a Taxonomy Maintenance Page. FIG. 15 is an embodiment of a representative Taxonomy Maintenance Page screen display 870. The Taxonomy Maintenance Page screen display 870 is provided to the administrator to update the taxonomies of content components as appropriate. The administrative person can add, delete or modify details pertaining to the taxonomy (step 214 of FIG. 5). As shown in FIG. 15, taxonomy maintenance allows for the categorization of content by curriculum 872, selected subject areas for each curriculum 874 and a summary of the selected core categories for each subject area 876. The system can provide a list from which the administrator can select the curriculum, subject area and core category.

As shown in FIG. 5, an administrator can also expire or delete content (step 216). By clicking on the Search/Delete button 856 shown on the home page of FIG. 6, the administrator can search for content based on a variety of criteria. The search function used with this page can be like the author search page as shown and described with reference to in FIGS. 7A and 7B. The administrator can preview content and expire or delete that content (step 218 of FIG. 5). Content that is expired is removed from a course, but not deleted from the system.

As shown in FIG. 5, an administrator can also perform file maintenance on content on the system (step 220). By clicking on the Files button 858, the administrator can upload, remove and rename files on the system (step 222). In addition, the administrator is in charge of deleting unnecessary files and renaming files to adhere to the naming standards used in the system.

As shown in FIG. 5, the administrator can return to the system home page shown in FIG. 6 (step 224).

6. Graphical User Interface for the Course Building Tool

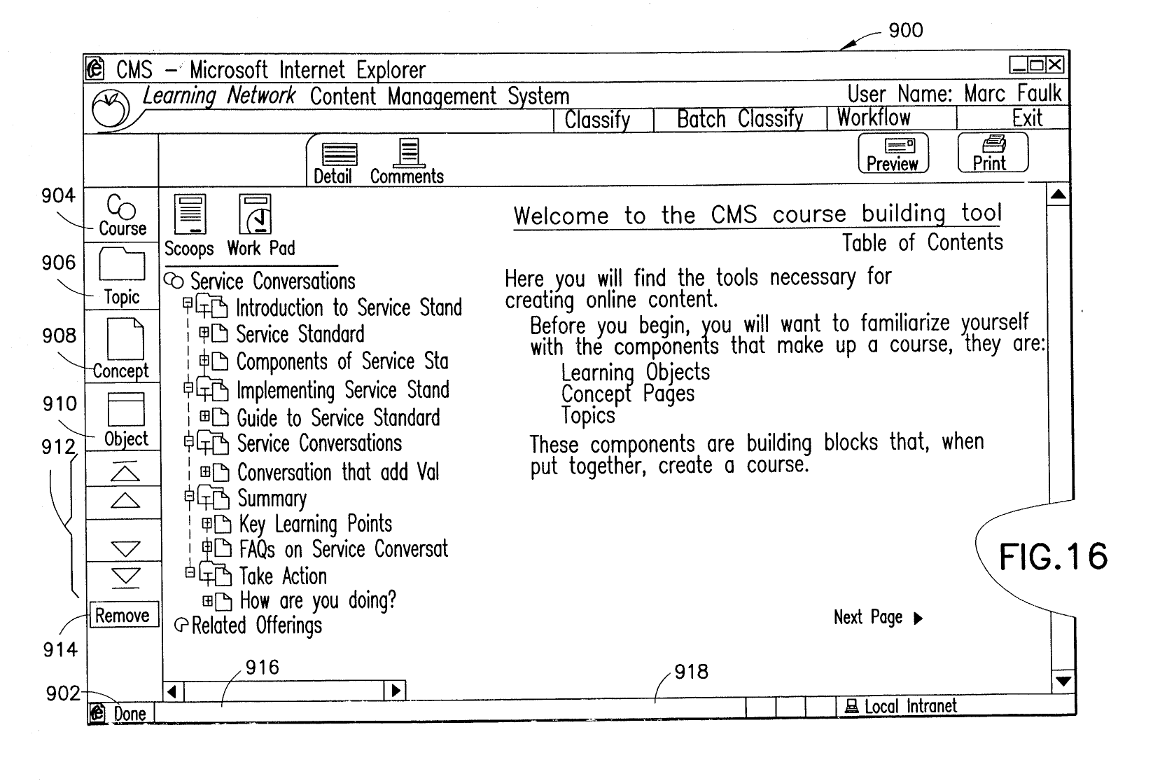

FIG. 16 is an embodiment of a representative graphical user interface 900 for use in the building of courses.

The left most frame 902 in the graphical user interface contains four buttons to add content. Those four buttons are the Course 904, Topic 906, Concept 908, and Object 910 buttons. Below those four buttons are arrows 912 which enable reordering of content. At the bottom of the left most column is a remove button 914 that allows for removal of content. Clicking on the Course, Topic, Concept, or Object buttons will lead the user to a Course Page, Topic Page, Concept Page and Learning Object Page, respectively. The middle frame 916 in the graphical user interface is a navigation tool that allows the user to see the entire structure of a course at all levels. The right most frame 918 displays previews of the course components or templates for data entry for building each course component. Clicking on an item in the middle frame 916 will reload this frame with the specific content as to that item.

Those skilled in the art would recognize that the system method of the present invention has many applications, and that the present invention is not limited to the representative examples disclose herein. Moreover, the scope of the present invention covers all conventionally known variations or modifications to the system components and the method steps described herein, as would be known by those skilled in the art.

What is claimed:

1. A system for delivery of on-line content, comprising:
a server computer including a hierarchical database;
the server computer is adapted to
receive information for inclusion in the hierarchical database;
search information contained in the hierarchical database at multiple levels in the hierarchical database;
retrieve information contained in the hierarchical database identified as a result of a search; and
build content from information received for inclusion in hierarchical database and from information retrieved from the hierarchical database.

2. The system of claim 1 wherein the hierarchical database includes objects, which represent units of information contained in the hierarchical database, and at least one larger unit of information, which represents a grouping of objects.

3. The system of claim 2 wherein the larger unit of information represents a concept.

4. The system of claim 2 wherein the larger unit of information represents a topic.

5. The system of claim 2 wherein the larger unit of information represents a course.

6. The system of claim 2 wherein the larger unit of information represents a series.

7. The system of claim 2 wherein the information in the hierarchical database can be searched at the object level.

8. The system of claim 3 wherein the information in the hierarchical database can be searched at the concept level.

9. The system of claim 4 wherein the information in the hierarchical database can be searched at the topic level.

10. The system of claim 5 wherein the information in the hierarchical database can be searched at the course level.

11. The system of claim 6 wherein the information in the hierarchical database can be searched at the series level.

12. The system of claim 7 wherein the information identified as a result of the search can be previewed.

13. The system of claim 7 wherein the content is built from information retrieved from the object level of the hierarchical database.

14. The system of claim 8 wherein the content is built from information retrieved from the concept level of the hierarchical database.

15. The system of claim 9 wherein the content is built from information retrieved from the topic level of the hierarchical database.

16. The system of claim 10 wherein the content is built from information retrieved from the course level of the hierarchical database.

17. The system of claim 11 wherein the content is built from information retrieved from the series level of the hierarchical database.

18. The system of claim 2 wherein information contained in the hierarchical database can be classified as part of an object or larger unit of information.

19. The system of claim 2 wherein there are various types of objects and the objects can be searched by type.

20. The system of claim 1 wherein the server computer is adapted to facilitate the performance of administrative functions.

21. The system of claim 20 wherein the administrative functions include adding a new user.

22. The system of claim 20 wherein the administrative functions include monitoring workflow.

23. The system of claim 1 wherein the system is used for the delivery of on-line courses.

24. An apparatus, comprising:
a programmed computer, further comprising:
a memory having at least one region for storing executable program code; and
a processor for executing the program code stored in the memory, wherein the program code, further comprises:
code to receive information for inclusion in a hierarchical database;
code to search information contained in the hierarchical database at multiple levels in the hierarchical database;
code to retrieve information contained in the hierarchical database identified as a result of a search; and
code to build content from information received for inclusion in hierarchical database and from information retrieved from the hierarchical database.

25. The apparatus of claim 24 wherein the hierarchical database includes objects, which represent units of information contained in the hierarchical database, and at least one larger unit of information, which represents a grouping of objects.

26. The apparatus of claim 25 wherein the larger unit of information represents a concept.

27. The apparatus of claim 25 wherein the larger unit of information represents a topic.

28. The apparatus of claim 25 wherein the larger unit of information represents a course.

29. The apparatus of claim 25 wherein the larger unit of information represents a series.

30. The apparatus of claim 25 further comprising code to search the information in the hierarchical database at the object level.

31. The apparatus of claim 26 further comprising code to search the information in the hierarchical database at the concept level.

32. The apparatus of claim 27 further comprising code to search the information in the hierarchical database at the topic level.

33. The apparatus of claim 28 further comprising code to search the information in the hierarchical database at the course level.

34. The apparatus of claim 29 further comprising code to search the information in the hierarchical database at the series level.

35. The apparatus of claim 30 further comprising code to preview information identified as a result of the search.

36. The apparatus of claim 30 further comprising code to build content from information retrieved from the object level of the hierarchical database.

37. The apparatus of claim 31 further comprising code to build content from information retrieved from the concept level of the hierarchical database.

38. The apparatus of claim 32 further comprising code to build content from information retrieved from the topic level of the hierarchical database.

39. The apparatus of claim 33 further comprising code to build content from information retrieved from the course level of the hierarchical database.

40. The apparatus of claim 34 further comprising code to build content from information retrieved from the series level of the hierarchical database.

41. The apparatus of claim 25 further comprising code to classify information contained in the hierarchical database as part of an object or larger unit of information.

42. The apparatus of claim 25 further comprising code to classify objects into various types and search the objects by type.

43. The apparatus of claim 24 further comprising code to facilitate the performance of administrative functions.

44. The apparatus of claim 43 wherein the administrative functions include adding a new user.

45. The apparatus of claim 43 wherein the administrative functions include monitoring workflow.

46. The apparatus of claim 24 wherein the apparatus is used for the delivery of on-line courses.

47. A method for delivery of on-line content, comprising:
receiving information for storage in a server computer as part of a hierarchical database;
storing the information received;
searching information contained in the hierarchical database at multiple levels in the hierarchical database;
retrieving information contained in the hierarchical database; and
building content from information received for inclusion in hierarchical database and from information retrieved from the hierarchical database.

48. The method of claim 47 wherein the hierarchical database includes objects, which represent units of information contained in the hierarchical database, and at least one larger unit of information, which represents a grouping of objects.

49. The method of claim 48 wherein the larger unit of information represents a concept.

50. The method of claim 48 wherein the larger unit of information represents a topic.

51. The method of claim 48 wherein the larger unit of information represents a course.

52. The method of claim 48 wherein the larger unit of information represents a series.

53. The method of claim 48 further comprising searching the information in the hierarchical database at the object level.

54. The method of claim 49 further comprising searching the information in the hierarchical database at the concept level.

55. The method of claim 50 further comprising searching the information in the hierarchical database at the topic level.

56. The method of claim 51 further comprising searching the information in the hierarchical database at the course level.

57. The method of claim 52 further comprising searching the information in the hierarchical database at the series level.

58. The method of claim 53 further comprising previewing the information identified as a result of the search.

59. The method of claim 53 further comprising building content from information retrieved from the object level of the hierarchical database.

60. The method of claim 54 further comprising building content from information retrieved from the concept level of the hierarchical database.

61. The method of claim 55 further comprising building content from information retrieved from the topic level of the hierarchical database.

62. The method of claim 56 further comprising building content from information retrieved from the course level of the hierarchical database.

63. The method of claim 57 further comprising building content from information retrieved from the series level of the hierarchical database.

64. The method of claim 48 further comprising classifying information contained in the hierarchical database as part of an object or larger unit of information.

65. The method of claim 48 further comprising classifying objects in various types and searching the objects by type.

66. The method of claim 47 further comprising performing administrative functions.

67. The method of claim 66 wherein the administrative functions include adding a new user.

68. The method of claim 66 wherein the administrative functions include monitoring workflow.

69. The method of claim 47 wherein the method is used for the delivery of on-line courses.

70. Computer executable software code stored on a computer readable medium, the code for delivery of on-line content, comprising:
code to receive information for inclusion in a hierarchical database;
code to search information contained in the hierarchical database at multiple levels in the hierarchical database;
code to retrieve information contained in the hierarchical database identified as a result of a search; and
code to build content from information received for inclusion in hierarchical database and from information retrieved from the hierarchical database.

71. The code of claim 70 wherein the hierarchical database includes objects, which represent units of information contained in the hierarchical database, and at least one larger unit of information, which represents a grouping of objects.

72. The code of claim 71 wherein the larger unit of information represents a concept.

73. The code of claim 71 wherein the larger unit of information represents a topic.

74. The code of claim 71 wherein the larger unit of information represents a course.

75. The code of claim 71 wherein the larger unit of information represents a series.

76. The code of claim 71 wherein the information in the hierarchical database can be searched at the object level.

77. The code of claim 72 wherein the information in the hierarchical database can be searched at the concept level.

78. The code of claim 73 wherein the information in the hierarchical database can be searched at the topic level.

79. The code of claim 74 wherein the information in the hierarchical database can be searched at the course level.

80. The code of claim 75 wherein the information in the hierarchical database can be searched at the series level.

81. The code of claim 76 further comprising code for previewing information identified as a result of the search.

82. The code of claim 77 further comprising code for building content from information retrieved from the object level of the hierarchical database.

83. The code of claim 77 further comprising building content from information retrieved from the concept level of the hierarchical database.

84. The code of claim 78 further comprising building content from information retrieved from the topic level of the hierarchical database.

85. The code of claim 79 further comprising building content from information retrieved from the course level of the hierarchical database.

86. The code of claim 80 further comprising building content from information retrieved from the series level of the hierarchical database.

87. The code of claim 71 further comprising classifying information contained in the hierarchical database as part of an object or larger unit of information.

88. The code of claim 71 further comprising classifying objects into various types of objects and searching the objects by type.

89. The code of claim 70 further comprising performing administrative functions.

90. The code of claim 89 wherein the administrative functions include adding a new user.

91. The code of claim 89 wherein the administrative functions include monitoring workflow.

92. The code of claim 70 wherein the code is used for the delivery of on-line courses.

93. An apparatus for delivery of on-line content, comprising:
means for receiving information for storage in a server computer as part of a hierarchical database;
means for storing the information received;
means for searching information contained in the hierarchical database at multiple levels in the hierarchical database;
means for retrieving information contained in the hierarchical database; and
means for building content from information received for inclusion in hierarchical database and from information retrieved from the hierarchical database.

94. The apparatus of claim 93 wherein the hierarchical database includes objects, which represent units of information contained in the hierarchical database, and at least one larger unit of information, which represents a grouping of objects.

95. The apparatus of claim 94 wherein the larger unit of information represents a concept.

96. The apparatus of claim 94 wherein the larger unit of information represents a topic.

97. The apparatus of claim 94 wherein the larger unit of information represents a course.

98. The apparatus of claim 94 wherein the larger unit of information represents a series.

99. The apparatus of claim 94 further comprising means for searching in the hierarchical database the information at the object level.

100. The apparatus of claim 95 further comprising means for searching the information in the hierarchical database at the concept level.

101. The apparatus of claim 96 further comprising means for searching the information in the hierarchical database at the topic level.

102. The apparatus of claim 97 further comprising means for searching the information in the hierarchical database at the course level.

103. The apparatus of claim 98 further comprising means for searching the information in the hierarchical database at the series level.

104. The apparatus of claim 99 further comprising means for previewing the information identified as a result of the search.

105. The apparatus of claim 99 further comprising means for building content from information retrieved from the object level of the hierarchical database.

106. The apparatus of claim 100 further comprising means for building content from information retrieved from the concept level of the hierarchical database.

107. The apparatus of claim 101 further comprising means for building content from information retrieved from the topic level of the hierarchical database.

108. The apparatus of claim 102 further comprising means for building content from information retrieved from the course level of the hierarchical database.

109. The apparatus of claim 103 further comprising means for building content from information retrieved from the series level of the hierarchical database.

110. The apparatus of claim 94 further comprising means for classifying information contained in the hierarchical database as part of an object or larger unit of information.

111. The apparatus of claim 94 further comprising means for classifying objects in various types and searching the objects by type.

112. The apparatus of claim 93 further comprising means for performing administrative functions.

113. The apparatus of claim 112 wherein the administrative functions include adding a new user.

114. The apparatus of claim 112 wherein the administrative functions include monitoring workflow.

115. The apparatus of claim 93 wherein the apparatus is used for the delivery of on-line courses.
